(19) United States
(12) Patent Application Publication
(10) Pub. No.: US 2023/0072832 A1
(43) Pub. Date: Mar. 9, 2023

(54) METHOD AND APPARATUS FOR CONSISTENT LBT FAILURE DETECTION AND RECOVERY IN CELL HANDOVER

(71) Applicant: FUJITSU LIMITED, Kawasaki-shi (JP)

(72) Inventors: Meiyi JIA, Beijing (CN); Guorong LI, Beijing (CN); Yang LU, Beijing (CN); Lei ZHANG, Beijing (CN)

(73) Assignee: FUJITSU LIMITED, Kawasaki-shi (JP)

(21) Appl. No.: 17/983,572

(22) Filed: Nov. 9, 2022

Related U.S. Application Data
(63) Continuation of application No. PCT/CN2020/091672, filed on May 21, 2020.

(51) Int. Cl. H04W 36/00; H04W 74/08

(52) U.S. Cl. CPC H04W 36/0079; H04W 74/0808

(57) ABSTRACT

A method and apparatus for consistent LBT failure detection and recovery in cell handover. The method is applicable to a terminal equipment and includes receiving a consistent LBT failure indication during cell handover, and suspending data transmission and/or reception with a network device and/or suspending consistent LBT failure detection and recovery during the cell handover.

### CROSS-REFERENCE TO RELATED APPLICATION

This application is a continuation application of International Application PCT/CN2020/091672 filed on May 21, 2020, and designated the U.S., the entire contents of which are incorporated herein by reference.

### TECHNICAL FIELD

This disclosure relates to the field of communication technologies.

### BACKGROUND

To provide 3GPP services in shared spectrum channel access, the following mechanisms are introduced: Listen Before Talk (LBT) and discovery RS measurement timing configuration (DMTC). A lower layer performs an LBT process, and according to an LBT result, if it is determined that a channel is occupied, no transmission is performed. When the lower layer performs the LBT process before transmission and the transmission is not performed, that is, when uplink transmission is blocked due to an LBT failure, the lower layer indicates the LBT failure to an MAC layer.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In the shared spectrum channel access, a consistent LBT failure detection and recovery mechanism is introduced. The consistent LBT failure detection and recovery mechanism refers to detecting possible consistent LBT failure and taking actions, so that a terminal is recovered from a detected consistent LBT failure. The consistent LBT failure detection and recovery mechanism may also be referred to as an uplink transmission consistent LBT failure detection and recovery mechanism, an LBT failure detection and recovery mechanism, an uplink LBT failure detection and recovery mechanism, or a consistent uplink LBT failure detection and recovery mechanism.

The consistent LBT failure detection and recovery mechanism may be an LBT failure detection process (also referred to as an uplink transmission consistent LBT failure detection process), or an LBT failure recovery process (also referred to as an uplink transmission consistent LBT failure recovery process), or may include both an LBT failure detection process (also referred to as an uplink transmission consistent LBT failure detection process) and an LBT failure recovery process (also referred to as an uplink transmission consistent LBT failure recovery process).

A radio resource control (RRC) layer may configure a consistent LBT failure recovery process for a media access control (MAC) entity of an MAC layer. Consistent LBT failure detection is performed on each uplink bandwidth part (BWP). The MAC entity performs detection by counting the number of LBT failure indications of all uplink transmissions received from a lower layer (e.g. a physical layer). For this purpose, an LBT counter (e.g. LBT_COUNTER) and a timer are introduced. When an uplink LBT failure occurs, the timer is started or restarted, whenever the MAC layer receives an uplink LBT failure indication from the lower layer, the counter is incremented by 1, and when a count value exceeds a preset value, a consistent LBT failure is triggered. And furthermore, when the timer expires, the counter is reset.

For example, for a serving cell configured with an LBT failure recovery configuration parameter (e.g. lbt-FailureRecoveryConfig), if an LBT failure indication is received from the lower layer and if the LBT counter (e.g. LBT_COUNTER) is greater than or equal to a maximum value of LBT failure (e.g. lbt-FailurelnstanceMaxCount), the MAC entity will trigger a consistent LBT failure on a BWP of the serving cell (also referred to as a consistent LBT failure on the uplink BWP activated by the serving cell).

For example, when the serving cell is a special cell (SpCell), if consistent LBT failure has been triggered in all uplink BWPs configured with physical random access channel (PRACH) occasions on same carrier in the serving cell, the MAC entity will indicate the consistent LBT failures to a higher layer (such as the RRC layer); otherwise, the MAC entity will stop any ongoing random access procedure in the serving cell and switch active UL BWP to a UL BWP in the serving cell with PRACH occasions configured on the same carrier and for which consistent LBT failure has not been triggered, and initiate a random access procedure.

Cell handover refers to a process in which a terminal equipment is handed over from performing data transmission with a network via a source cell to performing data transmission with the network via a target cell, which includes three processes, handover preparation, handover execution and handover completion. During the handover execution, a network device of the source cell transmits an RRC reconfiguration message (RRCReconfiguration message) to the terminal equipment to trigger Uu handover, that is, handover between a source cell and a target cell involved in the Uu interface. The message includes information needed in accessing to the target cell; and the terminal equipment is synchronized to the target cell and completes an RRC handover procedure by transmitting an RRC reconfiguration complete message (RRCReconfigurationComplete message) to a network device of the target cell. In a case where the cell handover is of dual active protocol stack (DAPS) handover, when the terminal equipment receives the RRC reconfiguration message, the terminal equipment does not detach from the source cell, and continues to perform data transmission with the network device of the source cell. And upon receiving an explicit release from the network device of the target cell, the terminal equipment releases a signaling radio bearer (SRB) resource of the source cell and security configuration of the source cell, and suspends downlink and/or uplink (DL/UL) transmission with the source cell.

It was found by the inventors that when the consistent LBT failure detection and recovery mechanism is applied during cell handover, according to an existing cell handover mechanism, if no data bearer (data RB, DRB) is configured with DAPS, when the terminal equipment receives a consistent uplink LBT failure indication of primary cell group (MCG) MAC, the terminal equipment will consider that the MCG announces the radio link failure, and discard segments the received segmented RRC message and store radio link failure information, and if a timer T316 does not configure secondary cell group (SCG) transmission or SCG transmission is suspended or a primary secondary cell (PSCell) change is in progress, a connection reestablishment process is initiated.

If the consistent uplink LBT failure indication of the MCG MAC is received during the cell handover, if the consistent LBT failure indication is on the target cell, according to an existing mechanism, the terminal equipment will perform connection reestablishment, regardless of whether the handover is successful or not. In addition, in a case of cell handover is of DAPS handover, if the consistent LBT failure indication is on the source cell, according to the existing mechanism, the terminal equipment will perform connection reestablishment, regardless of whether the handover is successful or not.

In practice, if the terminal equipment does not perform connection reestablishment, the terminal equipment may use the target cell for transmission after the handover is successful. Therefore, the existing mechanism may possibly cause unnecessary connection reestablishment, resulting in interruption of user services and degradation of user experiences.

In order to solve one or more of the above problems, embodiments of this disclosure provide a method and apparatus for consistent LBT failure detection and recovery in cell handover.

According to a first aspect of the embodiments of this disclosure, there is provided an apparatus for consistent LBT failure detection and recovery in cell handover, applicable to a terminal equipment, the apparatus including: a first processing unit configured to receive a consistent LBT failure indication during cell handover, and stop data transmission and/or reception with a network device; and/or a second processing unit configured to suspend consistent LBT failure detection and recovery during the cell handover.

According to a second aspect of the embodiments of this disclosure, there is provided an apparatus for consistent LBT failure detection and recovery in cell handover, applicable to a terminal equipment, the apparatus including: a third processing unit configured to, during cell handover, when a consistent LBT failure indication is received, stop data transmission and/or reception with a network device; and/or, a fourth processing unit configured to, during cell handover, suspend consistent LBT failure detection and recovery.

According to a third aspect of the embodiments of this disclosure, there is provided an apparatus for consistent LBT failure detection and recovery in cell handover, applicable to a network device, the apparatus including: a first transmitting unit configured to transmit an RRC reconfiguration message to a terminal equipment, the RRC reconfiguration message including configuration information on LBT failure detection and recovery.

According to a fourth aspect of the embodiments of this disclosure, there is provided a terminal equipment, including the apparatus as described in the first or second aspect of the embodiments of this disclosure.

According to a fifth aspect of the embodiments of this disclosure, there is provided a network device, including the apparatus as described in the third aspect of the embodiments of this disclosure.

According to a sixth aspect of the embodiments of this disclosure, there is provided a communications system, including the terminal equipment as described in the fourth aspect of the embodiments of this disclosure and/or the network device as described in the fifth aspect of the embodiments of this disclosure.

According to a seventh aspect of the embodiments of this disclosure, there is provided a method for consistent LBT failure detection and recovery in cell handover, applicable to a terminal equipment, the method including: receiving a consistent LBT failure indication during cell handover, and suspending data transmission and/or reception with a network device; and/or suspending consistent LBT failure detection and recovery during the cell handover.

According to an eighth aspect of the embodiments of this disclosure, there is provided a method for consistent LBT failure detection and recovery in cell handover, applicable to a terminal equipment, the method including: during cell handover, when a consistent LBT failure indication is received, suspending data transmission and/or reception with a network device; and/or, during cell handover, suspending consistent LBT failure detection and recovery.

According to a ninth aspect of the embodiments of this disclosure, there is provided a method for consistent LBT failure detection and recovery in cell handover, applicable to a network device, the method including: transmitting a RRC reconfiguration message to a terminal equipment, the RRC reconfiguration message including configuration information on LBT failure detection and recovery.

According to a tenth aspect of the embodiments of this disclosure, there is provided a computer readable program, which, when executed in an apparatus for consistent LBT failure detection and recovery in cell handover or a terminal equipment, will cause the apparatus for consistent LBT failure detection and recovery in cell handover or the terminal equipment to carry out the method for consistent LBT failure detection and recovery in cell handover as described in the seventh or eighth aspect of the embodiments of this disclosure.

According to an eleventh aspect of the embodiments of this disclosure, there is provided a computer storage medium, including a computer readable program code, which will cause an apparatus for consistent LBT failure detection and recovery in cell handover or a terminal equipment to carry out the method for consistent LBT failure detection and recovery in cell handover as described in the seventh or eighth aspect of the embodiments of this disclosure.

According to a twelfth aspect of the embodiments of this disclosure, there is provided a computer readable program, which, when executed in an apparatus for consistent LBT failure detection and recovery in cell handover or a network device, will cause the apparatus for consistent LBT failure detection and recovery in cell handover or the network device to carry out the method for consistent LBT failure detection and recovery in cell handover as described in the ninth aspect of the embodiments of this disclosure.

According to a thirteenth aspect of the embodiments of this disclosure, there is provided a computer storage medium, including a computer readable program which will cause an apparatus for consistent LBT failure detection and recovery in cell handover or a network device to carry out the method for consistent LBT failure detection and recovery in cell handover as described in the ninth aspect of the embodiments of this disclosure.

An advantage of the embodiments of this disclosure exists in that during cell handover, when a consistent LBT failure indication is received, the terminal equipment suspends data transmission and/or reception with the network device, and/or, during cell handover, the terminal equipment suspends consistent LBT failure detection and recovery. In this way, during the cell handover, the terminal equipment will not initiate a connection reestablishment process due to the consistent LBT failure, thereby avoiding interruption of user services and degradation of user experiences.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communications system of an embodiment of this disclosure;

FIG. 2 is a schematic diagram of a cell handover process of an embodiment of this disclosure;

FIG. 3 is a schematic diagram of the method for consistent LBT failure detection and recovery in cell handover of Embodiment 1 of this disclosure;

FIG. 4 is another schematic diagram of the method for consistent LBT failure detection and recovery in cell handover of Embodiment 1 of this disclosure;

FIG. 5 is a schematic diagram of suspending data transmission and/or reception with the network device of Embodiment 1 of this disclosure;

FIG. 6 is another schematic diagram of suspending data transmission and/or reception with the network device of Embodiment 1 of this disclosure;

FIG. 7 is a further schematic diagram of suspending data transmission and/or reception with the network device of Embodiment 1 of this disclosure;

FIG. 8 is a schematic diagram of the method for consistent LBT failure detection and recovery in cell handover of Embodiment 2 of this disclosure;

FIG. 9 is a schematic diagram of the method for consistent LBT failure detection and recovery in cell handover of Embodiment 3 of this disclosure;

FIG. 10 is a schematic diagram of the apparatus for consistent LBT failure detection and recovery in cell handover of Embodiment 4 of this disclosure;

FIG. 11 is a schematic diagram of the apparatus for consistent LBT failure detection and recovery in cell handover of Embodiment 5 of this disclosure;

FIG. 12 is a block diagram of a systematic structure of the terminal equipment of Embodiment 6 of this disclosure; and

FIG. 13 is a block diagram of a systematic structure of the network device of Embodiment 7 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc. And communication between devices in a communications system may be performed according to communication protocols at any stage, which may, for example, include but not limited to the following communication protocols: 1G (genescalen), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communications system that accesses a user equipment to the communication network and provides services for the user equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, an MAChine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, all of “when . . . ”, “in a case where . . . ”, “for a case where . . . ” and “if . . . ” denote one or some conditions or states, and furthermore, all of these expressions are interchangeable.

Scenarios of the embodiments of this disclosure shall be described below by way of examples; however, this disclosure is not limited thereto.

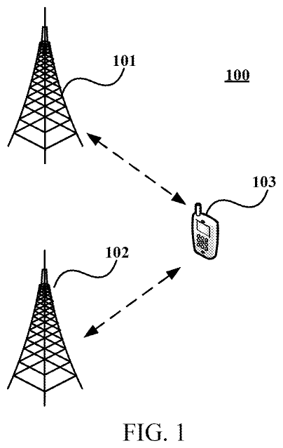

FIG. 1 is a schematic diagram of a communications system of an embodiment of this disclosure, in which a case where a terminal equipment and network devices are taken as examples is schematically shown. As shown in FIG. 1, a communications system 100 may include a first network device 101 and a second network device 102 and a terminal equipment 103. For the sake of simplicity, an example having only one terminal equipment is schematically given in FIG. 1. The first network device 101 and the second network device 102 are, for example, network devices gNBs of NR.

In the embodiment of this disclosure, existing traffics or traffics that may be implemented in the future may be performed between the first network device 101, the second network device 102 and the terminal equipment 103. For example, such traffics may include but not limited to enhanced mobile broadband (eMBB), massive machine type communication (MTC), and ultra-reliable and low-latency communication (URLLC), etc.

For example, the terminal equipment 103 performs cell handover, the first network device 101 is a network device of a source cell in the cell handover, and the second network device 102 is a network device of a target cell in the cell handover, for example, the first network device 101 is a source network device or a source base station, and the second network device 102 is a target network device or a target base station. In addition, the first network device 101 may cover multiple cells including the source cell, and the multiple cells may be referred to as cells belonging to the first network device 101; the second network device 102 may cover multiple cells including the target cell cells, the multiple cells may be referred to as cells belonging to the second network device 102.

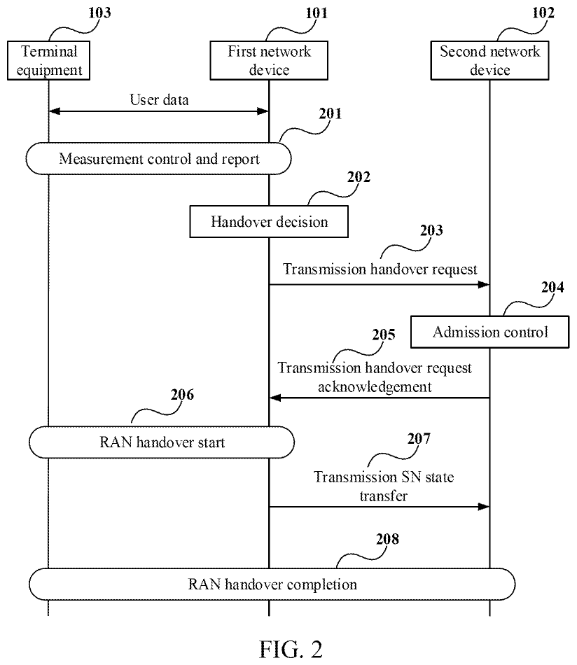

FIG. 2 is a schematic diagram of a cell handover process of an embodiment of this disclosure. As shown in FIG. 2, user data exchange is performed between the terminal equipment 103 and the first network device 101 of the source cell. In step 201, the terminal equipment 103 performs measurement control and reports; in step 202, the first network device 101 executes handover decision; in step 203, the first network device 101 transmits a handover request to the second network device 102; in step 204, the second network device 102 executes admission control; in step 205, the second network device 102 transmits a handover request acknowledge message to the first network device 101, the handover request acknowledge message including information needed in accessing to the target cell and configuration information related to LBT failure detection and recovery, the configuration information related to LBT failure detection and recovery being configuration information for performing consistent LBT failure detection and recovery by the terminal on a cell in the target network device; in step 206, RAN handover initiation is performed, specifically, the first network device 101 transmits an RRC reconfiguration (RRCReconfiguration) message to the terminal equipment 103 to trigger Uu handover, that is, handover between a source cell and a target cell involved in the Uu port, the message including information needed in accessing to the target cell and configuration information related to LBT failure detection and recovery; in step 207, the first network device 101 transmits SN status transfer to the second network device 102; in step 208, the terminal equipment 103 executes RAN handover completion, specifically, the terminal equipment 103 is synchronized to the target cell and completes an RRC handover procedure by transmitting an RRC reconfiguration complete (RRCReconfigurationComplete) message to the second network device 102 of the target cell. In a case where the cell handover is dual active protocol stack (DAPS) handover, when the terminal equipment 103 receives the RRC reconfiguration message, the terminal equipment 103 does not detach from the source cell and continues downlink and/or uplink (DL/UL) transmission with the source cell. When explicit release from the second network device 102 of the target cell is received, the terminal equipment 103 releases a signaling radio bearer (SRB) resource of the source cell and security configuration of the source cell, and suspends downlink and/or uplink (DL/UL) transmission with the source cell.

During cell handover, for example, during the period from step 206 to step 208 in FIG. 2, that is, during execution of handover, when the terminal equipment 103 performs LBT on uplink transmission to be performed by the terminal equipment on the source cell and/or the target cell, LBT failure may possibly occur, and when an MAC layer of the terminal equipment 103 receives an LBT failure indication from a physical layer and an LBT counter is greater than or equal to a maximum value of LBT failure, the MAC layer of the terminal equipment 103 triggers a consistent LBT failure on an active BWP of the source cell and/or the target cell. If all BWPs in the serving cell configured with physical random access channel (PRACH) occasions on identical carriers trigger consistent LBT failures, the MAC indicates the consistent LBT failures to a higher layer. If the consistent LBT failure indication is provided by a target MAC, that is, the consistent LBT failure is indicated to the higher layer due to consistent LBT failure on the target cell, according to an existing mechanism, the terminal equipment 103 will perform connection reestablishment, regardless of whether the handover is successful. In addition, in the case where the cell is DAPS handover, if the consistent LBT failure indication is provided by a source MAC, that is, the consistent LBT failure is indicated to the higher layer due to the consistent LBT failure on the source cell, according to the existing mechanism, the terminal equipment 103 will perform connection reestablishment, regardless of whether the handover is successful. In practice, if the terminal equipment 103 does not perform connection reestablishment, the terminal equipment 103 may use the target cell for transmission after the handover is successful. Therefore, the existing mechanism may cause unnecessary connection reestablishment, resulting in interruption of user services and degradation user experiences.

Various implementations of the embodiments of this disclosure shall be described below with reference to the accompanying drawings. These implementations are illustrative only, and are not intended to limit this disclosure.

### Embodiment 1

The embodiment of this disclosure provides a method for consistent LBT failure detection and recovery in cell handover, applicable to a terminal equipment, such as the terminal equipment 103 in FIG. 1.

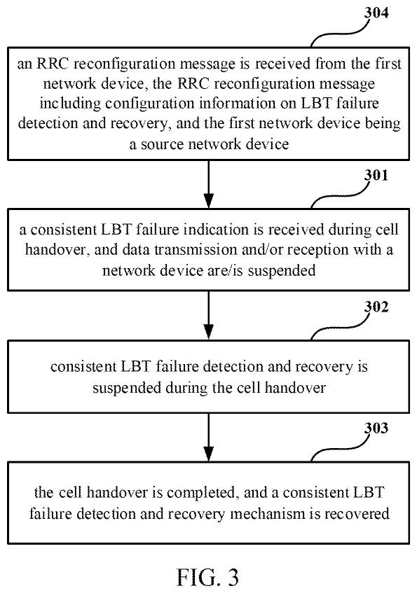

FIG. 3 is a schematic diagram of the method for consistent LBT failure detection and recovery in cell handover of Embodiment 1 of this disclosure. As shown in FIG. 3, the method includes:

Step 301: a consistent LBT failure indication is received during cell handover, and data transmission and/or reception with a network device are/is suspended; and/or Step 302: consistent LBT failure detection and recovery is suspended during the cell handover.

In the embodiment of this disclosure, the method for consistent LBT failure detection and recovery refers to a method for detecting a consistent LBT failure and a method for making the terminal equipment recovered from the consistent LBT failure.

In the embodiment of this disclosure, during the cell handover refers to during cell handover is performed, for example, during cell handover refers to during execution of handover, such as during the period from step 206 to step 208 in FIG. 2.

In step 301, during the cell handover, the terminal equipment receives the consistent LBT failure indication, and the terminal equipment suspends data transmission and/or reception with the network device. For example, during cell handover, when the terminal equipment receives the consistent LBT failure indication, the terminal equipment suspends data transmission and/or reception with the network device. For another example, during cell handover, the terminal equipment receives the consistent LBT failure indication, and when other conditions are satisfied, the terminal equipment suspends data transmission and/or reception with the network device.

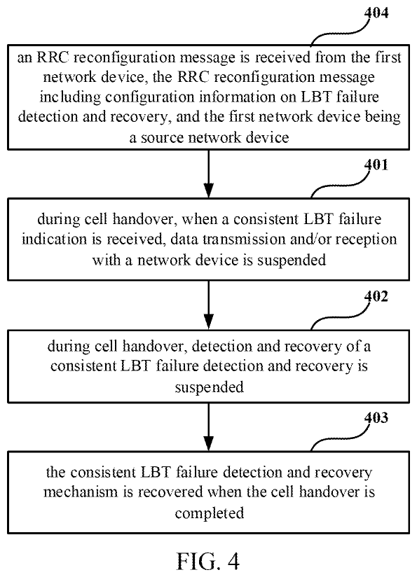

FIG. 4 is another schematic diagram of the method for consistent LBT failure detection and recovery in cell handover of Embodiment 1 of this disclosure. As shown in FIG. 4, the method includes:

Step 401: during cell handover, when a consistent LBT failure indication is received, data transmission and/or reception with a network device is suspended, and/or,

Step 402: during cell handover, detection and recovery of a consistent LBT failure detection and recovery is suspended.

In this way, during the cell handover, in receiving the consistent LBT failure indication, the terminal equipment suspends data transmission and/or reception with the network device, and/or, during the cell handover, the terminal equipment suspends the consistent LBT failure detection and recovery. Thus, during the cell handover, the terminal equipment will not initiate a connection reestablishment process due to the consistent LBT failure, thereby avoiding interruption of user services and degradation of user experiences.

In the embodiment of this disclosure, for example, that the terminal equipment receives the consistent LBT failure indication refers to that an RRC layer of the terminal equipment receives the consistent LBT failure indication.

In the embodiment of this disclosure, the consistent LBT failure indication is also referred to as a consistent uplink LBT failure indication.

For example, the physical layer of the terminal equipment performs LBT on uplink transmission, and when the LBT fails, indicates the LBT failure to the MAC layer. When the MAC layer receives the LBT failure indication from the physical layer, a count value LBT_COUNTER is incremented by 1, and when the count value exceeds a preset value, such as LBT_COUNTER≥lbt-FailureInstanceMaxCount, the MAC layer triggers a consistent LBT failure.

For example, when the serving cell is a special cell (SpCell), if an uplink BWP (UL BWP) activated by the serving cell triggers a consistent LBT failure, it is switched to another BWP and initiates random access; and if consistent LBT failure has been triggered in all uplink BWPs configured with physical random access channel (PRACH) occasions on same carrier in the serving cell, the MAC indicates the consistent LBT failures to a higher layer, such as an RRC layer.

In the embodiment of this disclosure, the cell handover may be dual active protocol stack (DAPS) handover, or dual active protocol stack (DAPS) handover and non-DAPS handover, or non-DAPS handover.

For example, the dual active protocol stack (DAPS) handover refers to performing reconfiguration with sync, and if dapsConfig is configured for any DRB; the dual active protocol stack (DAPS) handover and non-DAPS handover refers to performing reconfiguration with sync; and the non-DAPS handover refers to reconfiguration with sync and any DRB is configured with no dapsConfig.

In the embodiment of this disclosure, the cell handover refers to a process in which the terminal equipment is handed over from performing data transmission with the network via the source cell to performing data transmission with the network via the target cell.

For example, the source cell belongs to a first network device, the target cell belongs to a second network device, the first network device may be referred to as a source base station, and the second network device may be referred to as a target base station.

For example, in a case where the terminal equipment is configured with neither carrier aggregation (CA) nor dual connectivity (DC), the source cell and the target cell are serving cells respectively.

For example, in a case where the terminal equipment is configured with carrier aggregation and/or dual connectivity, the source cell and the target cell are primary cells.

In addition, for the case where the terminal equipment is configured with carrier aggregation and/or dual connectivity, the first network device may cover multiple cells, and the multiple cells may include the source cell (primary cell), and may also include other cells, such as secondary cells; and the second network device may also cover multiple cells, and the multiple cells include the target cell (primary cell), and may also include other cells, such as secondary cells.

In the embodiment of this disclosure, for a cell, the method may include both steps 301 and 302, or both steps 401 and 402.

Corresponding to steps 301 and 302, for example, during the cell handover, a consistent LBT failure indication is received, and/or data transmission and/or reception with the network device is suspended; and consistent LBT failure detection and recovery are suspended.

That is,

for example, during the cell handover, the consistent LBT failure indication is received, and the consistent LBT failure detection and recovery are suspended;

for example, during the cell handover, data transmission and/or reception with network device is/are suspended; and the consistent LBT failure detection and recovery are suspended;

for example, during the cell handover, the consistent LBT failure indication is received, and data transmission and/or reception with the network device is/are suspended; and consistent LBT failure detection and recovery are suspended.

Corresponding to steps 401 and 402, for example, during the cell handover, when the consistent LBT failure indication is received, and/or, when the data transmission and/or reception with the network device is/are suspended, the consistent LBT failure detection and recovery are suspended.

That is, for example, during the cell handover, when the consistent LBT failure indication is received, the consistent LBT failure detection and recovery are suspended;

for example, during the cell handover, the consistent LBT failure detection and recovery are suspended when the data transmission and/or reception with the network device is/are suspended;

for example, during the cell handover, when the consistent LBT failure indication is received and data transmission and/or reception with the network device is/are suspended, the consistent LBT failure detection and recovery are suspended.

In the embodiment of this disclosure, for different cells, different steps in the method may be performed for different cells respectively, that is, different schemes are adopted for different cells, respectively.

For example, the cell handover is dual active protocol stack (DAPS) handover, and corresponding to steps 301 and 302, during the cell handover, the consistent LBT failure indication is received, and data transmission and reception with the first network device is suspended, and/or, during the cell handover, the consistent LBT failure detection and recovery for the second cell by the terminal equipment are suspended.

For another example, the cell handover is dual active protocol stack (DAPS) handover, and corresponding to steps 401 and 402, during the cell handover, when the consistent LBT failure indication is received, data transmission and reception with the first network device is suspended, and/or, during the cell handover, the consistent LBT failure detection and recovery for the second cell by the terminal equipment are suspended.

In the above examples, the second cell belongs to the second network device, the first network device is a source network device, and the second network device is a target network device. For example, the second cell may be a target cell, or may be another cell covered by the second network device, such as a secondary cell.

For example, the cell handover is dual active protocol stack (DAPS) handover, and during the cell handover, the consistent LBT failure indication is received, and data transmission and reception with the first network device is/are suspended, and/or, during the cell handover, the consistent LBT failure detection and recovery performed by the terminal equipment on the target cell are suspended, and the first network device is a source network device.

That is, for dual active protocol stack (DAPS) handover,

for example, during the cell handover, a consistent LBT failure indication is received, and data transmission and reception with the first network device are suspended;

for example, during the cell handover, the terminal equipment suspends consistent LBT failure detection and recovery performed on the target cell, and the first network device is a source network device;

for example, during the cell handover, a consistent LBT failure indication is received, and data transmission and reception with the first network device are suspended, and during the cell handover, consistent LBT failure detection and recovery performed on the target cell by the terminal equipment are suspended, and the first network device is a source network device.

In the embodiment of this disclosure, when an SCG and/or a secondary cell is/are reserved during the cell handover, for a primary cell, steps 301 and 302 may be performed, or steps 401 and 402 may be performed; and for a primary secondary cell and a secondary cell, step 302 or step 402 may be performed.

In step 301 and/or step 401, the received consistent LBT failure indication is from the MAC layer of the terminal equipment. For example, the consistent LBT failure indication is from at least one of a source MAC entity, a target MAC entity, and an MCG MAC entity, of the terminal equipment.

For example, in the case where the cell handover is DAPS handover, the consistent LBT failure indication is from the source MAC entity or the target MAC entity of the terminal equipment.

For example, in a case where a timer T304 is running, the consistent LBT failure indication is from the MCG MAC entity of the terminal equipment.

In step 301 and/or step 401, the suspending data transmission and/or reception with the network device may include at least one of the following:

suspending data transmission and/or reception with a first network device;

suspending data transmission and/or reception other than data transmitted related to random access with a second network device; and

suspending data transmission and/or reception with an MCG network device;

the first network device being a source network device, and the second network device being a target network device.

In the embodiment of this disclosure, for non-DAPS handover, for example, in step 301, during the cell handover, a consistent LBT failure indication from the MCG MAC entity of the terminal equipment is received, and data transmission and/or reception with an MCG network device is/are suspended. Correspondingly, in step 401, during the cell handover, when a consistent LBT failure indication from the MCG MAC entity of the terminal equipment is received, data transmission and/or reception with the MCG network device is/are suspended.

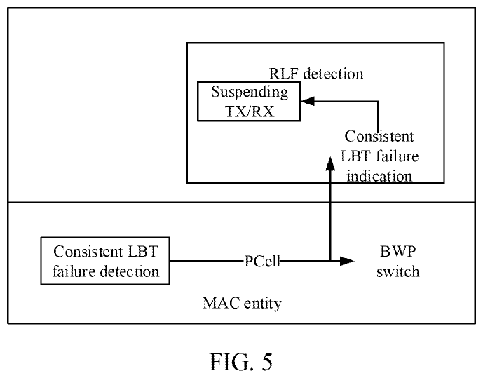

FIG. 5 is a schematic diagram of suspending data transmission and/or reception with the network device of Embodiment 1 of this disclosure. As shown in FIG. 5, the MAC entity performs consistent LBT failure detection. If an active uplink BWP (UL BWP) on a primary cell (PCell) triggers a consistent LBT failure, it is switched to another BWP and initiates random access, and if consistent LBT failure has been triggered in all uplink BWPs configured with physical random access channel (PRACH) occasions on same carrier in the serving cell, the MAC will indicate the consistent LBT failure to the RRC layer. The RRC entity will indicate consistent LBT failure to the RRC layer. The RRC layer performs radio link failure (RLF) detection, and when the RRC layer receives the consistent LBT failure indication from the MAC entity, it suspends data transmission and/or reception (TX/RX) with the network device.

In the embodiment of this disclosure, for the DAPS handover, for example, in step 301, during the cell handover, the consistent LBT failure indication is received from the source MAC entity of the terminal equipment, and data transmission and/or reception with the first network device is/are suspended. Correspondingly, in step 401, during the cell handover, when the consistent LBT failure indication is received from the source MAC entity of the terminal equipment, data transmission and/or reception with the first network device is/are suspended.

For the DAPS handover, for another example, in step 301, during the cell handover, the consistent LBT failure indication from the target MAC entity of the terminal equipment is received, and data transmission and/or reception with the second network device is/are suspended, or, data transmission and/or reception with the first network device and the second network device are suspended. Correspondingly, in step 401, during the cell handover, when the consistent LBT failure indication from the target MAC entity of the terminal equipment is received, transmission and/or reception of data other than data related to random access transmission with the second network device is/are suspended, or data transmission and/or reception with the first network device and transmission and/or reception of data other than data related to random access transmission with the second network device are suspended. That is, for the DAPS handover, the source MAC entity and the target MAC entity respectively perform consistent LBT failure detection and indicate the consistent LBT failures to the RRC layer respectively, and the RRC layer suspends the data transmission and/or reception with the first network device and/or the transmission and/or reception of data other than data related to random access transmission with the second network device.

Alternatively, it may also be that the source MAC entity and the target MAC entity respectively perform consistent LBT failure detection and indicate the consistent LBT failures to the RRC layer respectively, and upon receiving the consistent LBT failure indication from the source MAC entity and/or the target MAC entity, the RRC The layer suspends data transmission and/or reception with the first network device, and performs no action on the second network device, including performing no connection reestablishment.

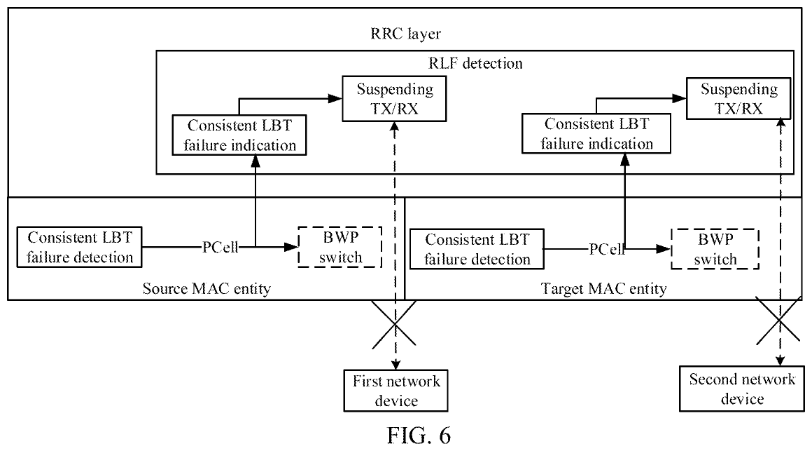

FIG. 6 is another schematic diagram of suspending data transmission and/or reception with the network device of Embodiment 1 of this disclosure. As shown in FIG. 6, the source MAC entity and the target MAC entity respectively perform consistent LBT failure detection and indicate the consistent LBT failure to the RRC layer respectively. If an active uplink BWP (UL BWP) on the primary cell (PCell) triggers a consistent LBT failure, it is switched to another BWP and initiates random access, and if consistent LBT failure has been triggered in all uplink BWPs configured with physical random access channel (PRACH) occasions on same carrier in the serving cell, the source MAC entity and/or the target MAC entity will indicate the consistent LBT failure to the RRC layer. The RRC layer performs radio link failure (RLF) detection, when the RRC layer receives the consistent LBT failure indication from the source MAC entity, it suspends data transmission and/or reception (TX/RX) with the first network device, and when the RRC layer receives the consistent LBT failure indication from the target MAC entity, it suspends the transmission and/or reception (TX/RX) of data other than data related to random access transmission with the second network device.

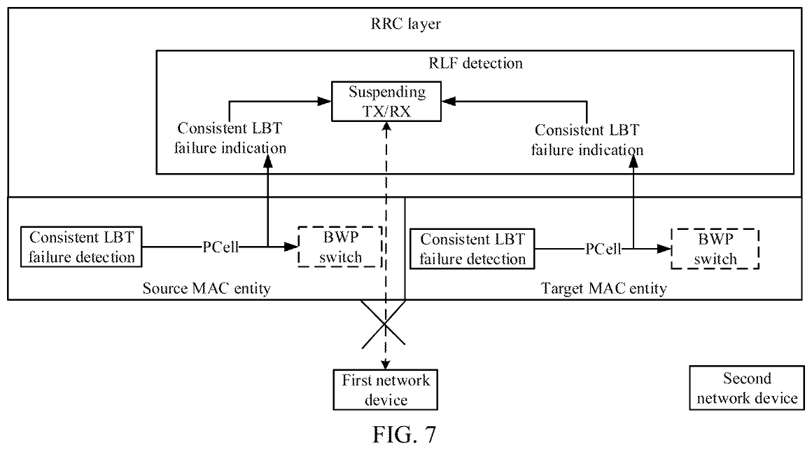

FIG. 7 is a further schematic diagram of suspending data transmission and/or reception with the network device of Embodiment 1 of this disclosure. As shown in FIG. 7, the source MAC entity and the target MAC entity respectively perform consistent LBT failure detection and indicate the consistent LBT failure to the RRC layer respectively. If an active uplink BWP (UL BWP) on the primary cell (PCell) triggers a consistent LBT failure, it is switched to another BWP and initiate random access, and if consistent LBT failure has been triggered in all uplink BWPs configured with physical random access channel (PRACH) occasions on same carrier in the serving cell, the source MAC entity and/or the target MAC entity will indicate the consistent LBT failures to the RRC layer. The RRC layer performs radio link failure (RLF) detection, when the RRC layer receives the consistent LBT failure indication from the source MAC entity and/or the target MAC entity, it suspends data transmission and/or reception (TX/RX) with the first network device, and performs no action on the second network device, including performing no connection reestablishment.

In the embodiment of this disclosure, the method may further include at least one of the following steps: maintaining in an RRC connection state by the terminal equipment; releasing connection with the first network device by the terminal equipment; maintaining RRC configuration of the first network device by the terminal equipment; and considering that a radio link with the first network device fails by the terminal equipment, wherein the first network device is a source network device.

In step 302 and/or step 402, during the cell handover, suspending the consistent LBT failure detection and recovery includes: during the cell handover, suspending the consistent LBT failure detection and recovery of the first cell and/or the second cell by the terminal equipment, the first cell belongs to a first network device, the second cell belongs to a second network device, the first network device is a source network device, and the second network device is a target network device.

The first cell is a serving cell or a primary cell or a primary secondary cell or a secondary cell, and/or, the second cell is a serving cell or a primary cell or a primary secondary cell or a secondary cell.

For example, in a case where the terminal equipment is neither configured with carrier aggregation (CA) nor dual connectivity (DC), the first cell is a serving cell, and the second cell is a serving cell.

For example, in a case where the terminal equipment is configured with carrier aggregation and/or dual connectivity, the first cell may be a primary cell or a primary secondary cell or a secondary cell, and the second cell may be a primary cell or a primary secondary cell or a secondary cell.

In step 302 and/or step 402, the suspending the consistent LBT failure detection and recovery includes at least one of the following:

suspending indicating the LBT failure by the physical layer to the MAC layer; for example, upon receiving an indication from RRC for suspending consistent LBT failure detection and recovery, the physical layer suspends indicating the LBT failure to the MAC layer; that is, in a case where no indication for suspending consistent LBT failure detection and recovery is received and the LBT fails, the physical layer indicates the LBT failure to the MAC layer;

not triggering a consistent LBT failure by the MAC layer; for example, the MAC layer does not trigger a consistent LBT failure upon receiving an indication from RRC for suspending consistent LBT failure detection and recovery; that is, for a serving cell configured with an LBT failure recovery configuration parameter, when no indication for suspending consistent LBT failure detection and recovery is received, an LBT failure indication is received from a lower layer and the LBT counter (e.g. LBT_COUNTER) is greater than or equal to the LBT failure maximum value (e.g. LBT_COUNTER≥lbt-FailureInstanceMaxCount), the MAC entity triggers a consistent LBT failure on a BWP of the serving cell;

not indicating the consistent LBT failure by the MAC layer to a higher layer (e.g. the RRC layer); for example, upon receiving an indication for suspending consistent LBT failure detection and recovery from RRC, the MAC layer does not indicate the consistent LBT failure to the higher layer; that is, when the serving cell that triggers the consistent LBT failure is a special cell, in a case where the indication for suspending consistent LBT failure detection and recovery is not received and consistent LBT failure has been triggered in all uplink BWPs configured with physical random access channel (PRACH) occasions on same carrier in the serving cell, the MAC entity will indicate the consistent LBT failures to the higher layer;

the consistent LBT failure indication is received and a timer for cell handover (such as T304) is not running, and a radio link is considered to fail; or, the consistent LBT failure indication is received when the timer (such as T304) is running, and a radio link is not considered to fail or the consistent LBT failure indication is neglected; and initiating connection reestablishment when a radio link failure occurs and the timer for cell handover (e.g. T304) is not running; or, not initiating connection reestablishment when the timer (e.g. T304) is running and a radio link failure occurs.

In step 302 and/or step 402, the suspending the consistent LBT failure detection and recovery may further include: indicating a lower layer by the RRC layer to suspend the consistent LBT failure detection and recovery.

For example, in order to perform reconfiguration with sync, or when the timer for cell handover is started, the RRC layer indicates the lower layer to suspend LBT failure detection and recovery.

In the embodiment of this disclosure, the lower layer is a physical layer and/or an MAC layer.

For example, the RRC indicates the physical layer to suspend consistent LBT failure detection and recovery. For example, when the physical layer receives an indication for suspending consistent LBT failure detection and recovery from the RRC, the physical layer suspends indicating the LBT failure to the MAC layer.

For example, the RRC indicates the MAC layer to suspend consistent LBT failure detection and recovery, e.g., when the MAC layer receives an indication from the RRC for suspending consistent LBT failure detection and recovery, the MAC layer does not trigger a consistent LBT failure, and/or, the MAC layer does not indicate a consistent LBT failure to the RRC layer.

For example, the RRC indicates the physical layer and the MAC layer to suspend consistent LBT failure detection and recovery, for example, when the physical layer receives an indication from the RRC for suspending consistent LBT failure detection and recovery, the physical layer suspends indicating the LBT failure to the MAC layer, and when the MAC layer receives the indication for suspending consistent LBT failure detection and recovery from the RRC, the MAC layer does not trigger a consistent LBT failure, and/or the MAC layer does not indicate a consistent LBT failure to the RRC layer.

In the embodiment of this disclosure, when the method includes step 302, as shown in FIG. 3, the method may further include:

Step 303: the cell handover is completed, and a consistent LBT failure detection and recovery mechanism is recovered.

For example, when the cell handover is completed, the consistent LBT failure detection and recovery mechanism is recovered.

For another example, when the cell handover is completed and another condition is satisfied, the consistent LBT failure detection and recovery mechanism is recovered.

Correspondingly, when the method includes step 402, as shown in FIG. 4, the method may further include:

Step 403: the consistent LBT failure detection and recovery mechanism is recovered when the cell handover is completed.

In the embodiment of this disclosure, that the cell handover is completed may refer to that execution of handover is completed or that the terminal equipment is synchronized to the target cell.

For example, the terminal equipment is synchronized to the target cell and completes the RRC handover procedure by transmitting an RRCReconfigurationComplete message to the target network device, that is, the execution of step 208 in FIG. 2 is completed.

In the embodiment of this disclosure, the recovering a consistent LBT failure detection and recovery mechanism may refer to recovering a suspended consistent LBT failure detection and recovery mechanism, such as recovering the consistent LBT failure detection and recovery mechanism suspended in step 302 and/or step 402.

In step 303 and/or step 403, the recovering consistent LBT failure detection and recovery mechanism includes at least one of the following:

indicating an LBT failure by a physical layer to an MAC layer when an indication of recovering consistent LBT failure detection and recovery is received and LBT fails;

for a serving cell configured with an LBT failure recovery configuration parameter, triggering consistent LBT failure on a BWP of the serving cell by an MAC entity when an indication of recovering consistent LBT failure detection and recovery is received, an LBT failure indication is received from a lower layer and an LBT counter (e.g. LBT_COUNTER) is greater than or equal to a maximum value of LBT failure (for example, LBT_COUNTER≥lbt-FailureInstanceMaxCount); and

indicating consistent LBT failure by the MAC entity to a higher layer when a serving cell in which consistent LBT failure is triggered is a special cell, an indication of recovering consistent LBT failure detection and recovery is received, and consistent LBT failure has been triggered in all uplink BWPs configured with physical random access channel (PRACH) occasions on same carrier in the serving cell.

In step 303 and/or step 403, it may further include: indicating the lower layer by the RRC layer to recover consistent LBT failure detection and recovery when the RRC handover is completed or when the terminal equipment is synchronized to a second cell, the second cell being a target cell.

In the embodiment of this disclosure, as shown in FIG. 3, the method may further include:

Step 304: an RRC reconfiguration message is received from the first network device, the RRC reconfiguration message including configuration information on LBT failure detection and recovery, and the first network device being a source network device.

Correspondingly, as shown in FIG. 4, the method may further include:

Step 404: an RRC reconfiguration message is received from the first network device, the RRC reconfiguration message including configuration information on LBT failure detection and recovery, and the first network device being a source network device.

In the embodiment of this disclosure, step 304 and/or step 404 is/are step 206 in FIG. 2 or a part of step 206 in FIG. 2.

In the embodiment of this disclosure, the configuration information on LBT failure detection and recovery may include first configuration information and/or second configuration information, the first configuration information being related to LBT failure detection and recovery of the first cell, the second configuration information being related to LBT failure detection and recovery of the second cell, the first cell being a cell belonging to the source network device, and the second cell being a cell belonging to a target network device.

For example, the first cell may be a serving cell, a primary cell, a primary secondary cell or a secondary cell belonging to the source network device, and the second cell may be a serving cell, a primary cell, a primary secondary cell or a secondary cell belonging to the target network device.

In the embodiment of this disclosure, the source MAC entity of the terminal equipment may perform consistent LBT failure detection and recovery on the first cell according to the first configuration information of LBT failure detection and recovery of the first cell; and/or, the target MAC entity of the terminal equipment may perform consistent LBT failure detection and recovery on the second cell according to the second configuration information of LBT failure detection and recovery of the second cell.

It can be seen from the above embodiment that during the cell handover, when the consistent LBT failure indication is received, the terminal equipment suspends data transmission and/or reception with the network device, and/or, during the cell handover, the terminal equipment suspends consistent LBT failure detection and recovery. In this way, during the cell handover, the terminal equipment will not initiate a connection reestablishment process due to the consistent LBT failure, thereby avoiding interruption of user services and degradation of user experiences.

### Embodiment 2

The embodiment of this disclosure provides a method for consistent LBT failure detection and recovery in cell handover. This method is applicable to a network device, and corresponds to the method for consistent LBT failure detection and recovery in cell handover applicable to a terminal equipment described in Embodiment 1, with identical contents being not going to be described herein any further.

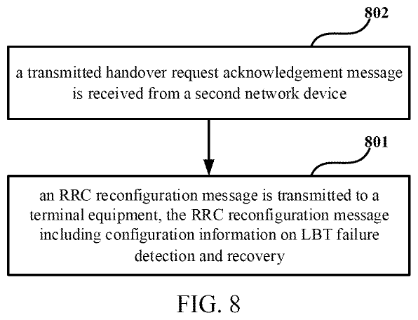

FIG. 8 is a schematic diagram of the method for consistent LBT failure detection and recovery in cell handover of Embodiment 2 of this disclosure. As shown in FIG. 8, the method includes:

Step 801: an RRC reconfiguration message is transmitted to a terminal equipment, the RRC reconfiguration message including configuration information on LBT failure detection and recovery.

In the embodiment of this disclosure, step 801 is step 206 in FIG. 2 or a part of step 206 in FIG. 2.

In the embodiment of this disclosure, the RRC reconfiguration message further includes information needed in accessing to a second cell, the second cell being a target cell.

In the embodiment of this disclosure, the network device is a source network device.

In the embodiment of this disclosure, the configuration information on LBT failure detection and recovery includes first configuration information and/or second configuration information, the first configuration information being related to LBT failure detection and recovery of a first cell, the second configuration information being related to LBT failure detection and recovery of a second cell, the first cell being a cell belonging to a source network device, and the second cell being a cell belonging to a target network device.

For example, the first cell may be a serving cell, a primary cell, a primary secondary cell or a secondary cell belonging to the source network device, and the second cell may be a serving cell, a primary cell, a primary secondary cell or a secondary cell belonging to the target network device.

In the embodiment of this disclosure, the configuration information related to LBT failure detection and recovery of the first cell is used by the source MAC entity of the terminal equipment to perform consistent LBT failure detection and recovery on the first cell, and/or the configuration information related to LBT failure detection and recovery of the second cell is used by the target MAC entity of the terminal equipment to perform consistent LBT failure detection and recovery on the second cell.

In the embodiment of this disclosure, as shown in FIG. 8, the method may further include:

Step 802: a transmitted handover request acknowledgement message is received from a second network device.

The second network device is a target network device.

In the embodiment of this disclosure, the handover request acknowledgement message may include information needed in accessing to the target cell and configuration information related to LBT failure detection and recovery, the configuration information related to LBT failure detection and recovery is configuration information for performing consistent LBT failure detection and recovery by a terminal on a cell in the target network device.

In the embodiment of this disclosure, step 802 is step 205 in FIG. 2 or a part of step 205 in FIG. 2.

It can be seen from the above embodiment that the network device transmits an RRC reconfiguration message including the configuration information related to LBT failure detection and recovery to the terminal equipment, so that the terminal equipment is able to perform consistent LBT failure detection according to the configuration information related to LBT failure detection and recovery.

### Embodiment 3

The embodiment of this disclosure provides a method for consistent LBT failure detection and recovery in cell handover. This method is applicable to a network device and a terminal equipment, and corresponds to the method for consistent LBT failure detection and recovery in cell handover applicable to a terminal equipment described in Embodiment 1 and the method for consistent LBT failure detection and recovery in cell handover applicable to a network device described in Embodiment 2, with identical contents being not going to be described herein any further.

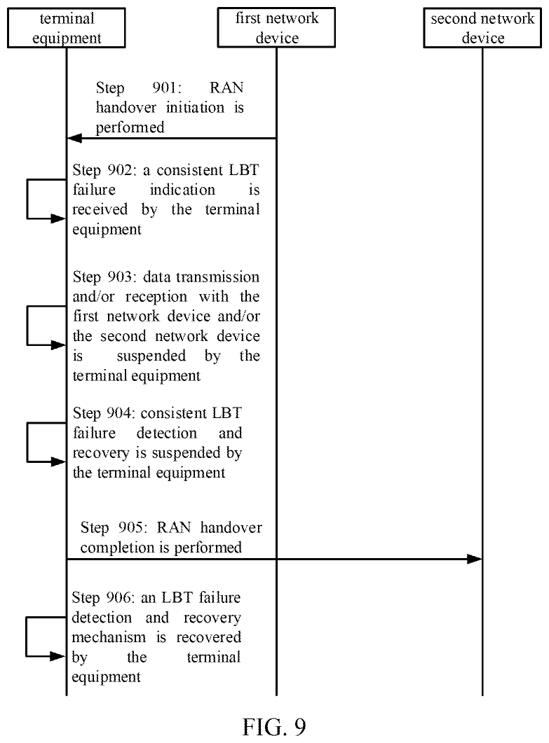

FIG. 9 is a schematic diagram of the method for consistent LBT failure detection and recovery in cell handover of Embodiment 3 of this disclosure. As shown in FIG. 9, the method includes:

Step 901: RAN handover initiation is performed; specifically, a first network device transmits an RRC reconfiguration message to the terminal equipment to trigger Uu handover, the RRC reconfiguration message including configuration information related to LBT failure detection and recovery; and in order to be synchronized to a target cell, the terminal equipment may initiate a random access procedure to a target cell in a second network device;

Step 902: a consistent LBT failure indication is received by the terminal equipment;

Step 903: data transmission and/or reception with the first network device and/or the second network device is suspended by the terminal equipment;

Step 904: consistent LBT failure detection and recovery is suspended by the terminal equipment;

Step 905: RAN handover completion is performed; specifically, the terminal equipment is synchronized to the target cell and completes the RRC handover procedure by transmitting an RRC reconfiguration complete (RRCReconfigurationComplete) message to the second network device of the target cell.

In the embodiment of this disclosure, the method may include step 903 and/or step 904, and when the method includes step 904, it may further include:

Step 906: an LBT failure detection and recovery mechanism is recovered by the terminal equipment.

In the embodiment of this disclosure, the first network device is a source network device, and the second network device is a target network device.

In the embodiment of this disclosure, reference may be made to the disclosure contained in Embodiment 1 and Embodiment 2 for particular implementations of the steps in FIG. 9, which shall not be described herein any further.

It can be seen from the above embodiment that during the cell handover, when the consistent LBT failure indication is received, the terminal equipment suspends data transmission and/or reception with the network device, and/or, during the cell handover, the terminal equipment suspends consistent LBT failure detection and recovery. In this way, during the cell handover, the terminal equipment will not initiate a connection reestablishment process due to the consistent LBT failure, thereby avoiding interruption of user services and degradation of user experiences.

### Embodiment 4

The embodiment of this disclosure provides an apparatus for consistent LBT failure detection and recovery in cell handover. As a principle of the apparatus for solving problems is similar to that of the method of Embodiment 1, reference may be made to the implementations of the method of Embodiment 1 for implementations of this apparatus, with identical or related parts being not going to be described herein any further.

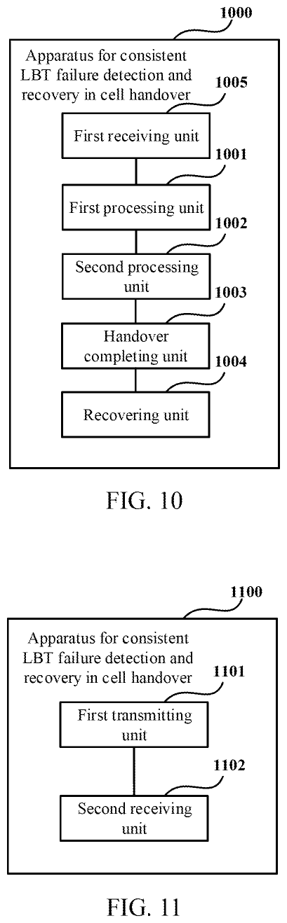

FIG. 10 is a schematic diagram of the apparatus for consistent LBT failure detection and recovery in cell handover of Embodiment 4 of this disclosure. As shown in FIG. 10, an apparatus 1000 includes:

a first processing unit 1001 configured to receive a consistent LBT failure indication during cell handover, and stop data transmission and/or reception with a network device; and/or a second processing unit 1002 configured to suspend consistent LBT failure detection and recovery during the cell handover.

In the embodiment of this disclosure, the first processing unit 1001 may also stop data transmission and/or reception with the network device during cell handover upon receiving a consistent LBT failure indication.

In the embodiment of this disclosure, the cell handover includes: dual active protocol stack (DAPS) handover, or dual active protocol stack (DAPS) handover and non-DAPS handover, or non-DAPS handover.

In the embodiment of this disclosure, as shown in FIG. 10, the apparatus 1000 may further include:

a handover completing unit 1003 configured to complete cell handover; and

a recovering unit 1004 configured to recover a consistent LBT failure detection and recovery mechanism.

For example, when the cell handover is completed, the recovering unit 1004 recovers the consistent LBT failure detection and recovery mechanism.

For another example, when the cell handover is completed and another condition is satisfied, the recovering unit 1004 recovers the consistent LBT failure detection and recovery mechanism.

In the embodiment of this disclosure, as shown in FIG. 10, the apparatus 1000 may further include:

a first receiving unit 1005 configured to receive an RRC reconfiguration message from a first network device, the RRC reconfiguration message including configuration information on LBT failure detection and recovery, and the first network device being a source network device.

In one implementation of the embodiment of this disclosure, the apparatus 1000 may further include at least one of the following units (not shown in FIG. 10):

a keeping unit configured to keep the terminal equipment in an RRC connected state;

a release unit configured to make the terminal equipment release connection with the first network device;

a maintaining unit configured to make the terminal equipment maintain RRC configuration of the first network device; or

a considering unit configured to make the terminal equipment consider that a radio link with the first network device fails,

the first network device being a source network device.

In one implementation of the embodiment of this disclosure, the apparatus 1000 may further include at least one of the following units (not shown in FIG. 10):

a first indicating unit configured to make the physical layer indicate the LBT failure to the MAC layer when no indication for suspending consistent LBT failure detection and recovery is received and the LBT fails;

a first triggering unit configured to, for a serving cell configured with an LBT failure recovery configuration parameter, make an MAC layer trigger a consistent LBT failure on a BWP of the serving cell when no indication for suspending consistent LBT failure detection and recovery is received, an LBT failure indication is received from a lower layer and an LBT counter is greater than or equal to an LBT failure maximum value; or

a second indicating unit configured to, when the serving cell that triggers the consistent LBT failure is a special cell and in a case where no indication for suspending consistent LBT failure detection and recovery is received and consistent LBT failure has been triggered in all uplink BWPs configured with physical random access channel (PRACH) occasions on same carrier in the serving cell, make the MAC entity to indicate the consistent LBT failures to the higher layer.

In this embodiment, reference may be made to the contents of relevant steps in Embodiment 1 for the implementations of the functions of the above units, which shall not be described herein any further.

It can be seen from the above embodiment that during the cell handover, when the consistent LBT failure indication is received, the terminal equipment suspends data transmission and/or reception with the network device, and/or, during the cell handover, the terminal equipment suspends consistent LBT failure detection and recovery. In this way, during the cell handover, the terminal equipment will not initiate a connection reestablishment process due to the consistent LBT failure, thereby avoiding interruption of user services and degradation of user experiences.

### Embodiment 5

The embodiment of this disclosure provides an apparatus for consistent LBT failure detection and recovery in cell handover. As a principle of the apparatus for solving problems is similar to that of the method of Embodiment 2, reference may be made to the implementations of the method of Embodiment 2 for implementations of this apparatus, with identical or related parts being not going to be described herein any further.

FIG. 11 is a schematic diagram of the apparatus for consistent LBT failure detection and recovery in cell handover of Embodiment 5 of this disclosure. As shown in FIG. 11, an apparatus 1100 includes:

a first transmitting unit 1101 configured to transmit an RRC reconfiguration message to a terminal equipment, the RRC reconfiguration message including configuration information on LBT failure detection and recovery.

In the embodiment of this disclosure, the RRC reconfiguration message may further include information needed in accessing to a second cell, the second cell being a target cell.

In the embodiment of this disclosure, the network device is a source network device.

In the embodiment of this disclosure, the configuration information related to LBT failure detection and recovery includes first configuration information and/or second configuration information, the first configuration information being related to LBT failure detection and recovery of a first cell, the second configuration information being related to the LBT failure detection and recovery of a second cell, the first cell being a cell belonging to the source network device, and the second cell being a cell belonging to a target network device.

For example, the first cell may be a serving cell, a primary cell, a primary secondary cell or a secondary cell belonging to the source network device, and the second cell may be a serving cell, a primary cell, a primary secondary cell or a secondary cell belonging to the target network device.

In the embodiment of this disclosure, the configuration information related to LBT failure detection and recovery of the first cell is used by a source MAC entity of the terminal equipment to perform consistent LBT failure detection and recovery on the first cell, and/or the configuration information related to LBT failure detection and recovery of the second cell is used by the target MAC entity of the terminal equipment to perform consistent LBT failure detection and recovery on the second cell.

In the embodiment of this disclosure, as shown in FIG. 11, the apparatus 1100 further includes:

a second receiving unit 1102 configured to receive a transmitted handover request acknowledgement message from a second network device, the second network device being a target network device.

In the embodiment of this disclosure, the handover request acknowledgement message may include information needed in accessing to a target cell and configuration information on LBT failure detection and recovery, the configuration information on LBT failure detection and recovery being configuration information on performing consistent LBT failure detection and recovery on a cell in the target network device by the terminal equipment.

It can be seen from the above embodiment that the network device transmits an RRC reconfiguration message including the configuration information related to LBT failure detection and recovery to the terminal equipment, so that the terminal equipment is able to perform consistent LBT failure detection according to the configuration information related to LBT failure detection and recovery.

### Embodiment 6

The embodiment of this disclosure provides a terminal equipment, including the apparatus for consistent LBT failure detection and recovery in cell handover as described in Embodiment 4.

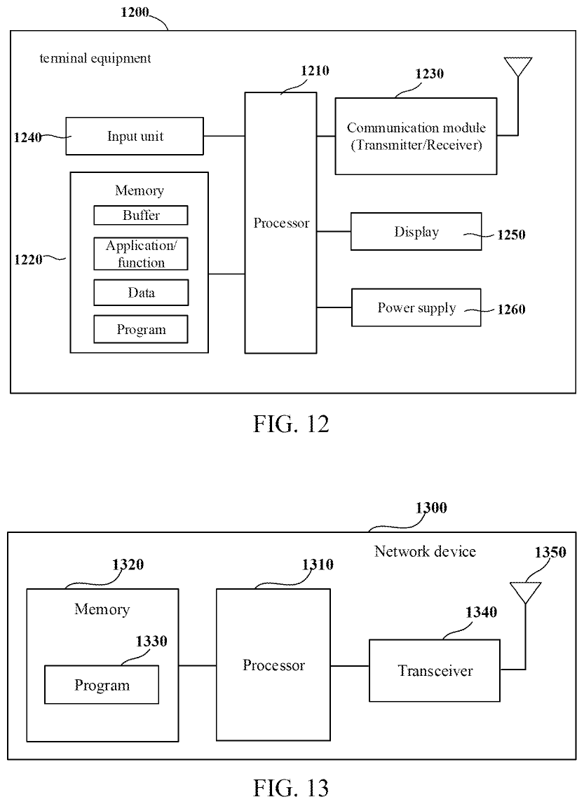

FIG. 12 is a block diagram of a systematic structure of the terminal equipment of Embodiment 6 of this disclosure. As shown in FIG. 12, a terminal equipment 1200 may include a processor 1210 and a memory 1220, the memory 1220 being coupled to the processor 1210. It should be noted that this figure is illustrative only, and other types of structures may also be used, so as to supplement or replace this structure and achieve a telecommunications function or other functions.

In one implementation, the functions of the apparatus for consistent LBT failure detection and recovery in cell handover may be integrated into the processor 1210.

The processor 1210 may be configured to: receive a consistent LBT failure indication during cell handover, and stop data transmission and/or reception with a network device, and/or, suspend consistent LBT failure detection and recovery during the cell handover.

For example, the cell handover includes: dual active protocol stack (DAPS) handover, or dual active protocol stack (DAPS) handover and non-DAPS handover, or non-DAPS handover.

For example, during the cell handover, when the consistent LBT failure indication is received, and/or, when the data transmission and/or reception with the network device is/are suspended, the consistent LBT failure detection and recovery are suspended.

For example, the cell handover is dual active protocol stack (DAPS) handover, during the cell handover, the consistent LBT failure indication is received, and data transmission and reception with the first network device is suspended, and/or, during the cell handover, the consistent LBT failure detection and recovery for the second cell by the terminal equipment are suspended, the first network device being a source network device.

For example, the received consistent LBT failure indication is from the MAC layer of the terminal equipment.

For example, that the received consistent LBT failure indication is from the MAC layer of the terminal equipment includes that the received consistent LBT failure indication is from at least one of a source MAC entity, a target MAC entity, and an MCG MAC entity, of the terminal equipment.

For example, the suspending data transmission and/or reception with the network device includes at least one of the following: suspending data transmission and/or reception with a first network device; suspending data transmission and/or reception other than data transmitted related to random access with a second network device; and suspending data transmission and/or reception with an MCG network device, the first network device being a source network device, and the second network device being a target network device.

For example, the processor 1210 may further be configured to execute at least one of the following steps: keeping the terminal equipment in an RRC connected state; making the terminal equipment release connection with the first network device; making the terminal equipment maintain RRC configuration of the first network device; or making the terminal equipment consider that a radio link with the first network device fails, the first network device being a source network device.

For example, during the cell handover, suspending the consistent LBT failure detection and recovery includes: during the cell handover, suspending the consistent LBT failure detection and recovery of the first cell and/or the second cell by the terminal equipment, the first cell belongs to a first network device, the second cell belongs to a second network device, the first network device is a source network device, and the second network device is a target network device.

For example, the first cell is a serving cell or a primary cell or a primary secondary cell or a secondary cell, and/or, the second cell is a serving cell or a primary cell or a primary secondary cell or a secondary cell.

For example, the suspending the consistent LBT failure detection and recovery includes at least one of the following: suspending indicating LBT failure by a physical layer to an MAC layer; not triggering consistent LBT failure by an MAC layer; not indicating consistent LBT failure by an MAC layer to a higher layer; receiving a consistent LBT failure indication and a timer used for cell handover being not operated, and considering that a radio link fails; or the timer being operated, receiving a consistent LBT failure indication, and not considering that a radio link fails or neglecting the consistent LBT failure indication; and radio link failure occurring, a timer used for cell handover being not operated, and initiating connection reestablishment; or the timer being operated, radio link failure occurring, and not initiating connection reestablishment.

For example, the processor 1210 may further be configured to execute at least one of the following steps: indicating an LBT failure by a physical layer to an MAC layer when no indication of recovering consistent LBT failure detection and recovery is received and LBT fails; for a serving cell configured with an LBT failure recovery configuration parameter, triggering consistent LBT failure on a BWP of the serving cell by an MAC entity when an indication of recovering consistent LBT failure detection and recovery is received, an LBT failure indication is received from a lower layer and an LBT counter is greater than or equal to a maximum value of LBT failure; and indicating consistent LBT failure by the MAC entity to a higher layer when a serving cell in which consistent LBT failure is triggered is a special cell, an indication of recovering consistent LBT failure detection and recovery is received, and consistent LBT failure has been triggered in all uplink BWPs configured with physical random access channel (PRACH) occasions on same carrier in the serving cell.

For example, the suspending the consistent LBT failure detection and recovery further includes:

indicating the lower layer by the RRC layer to suspend consistent LBT failure detection and recovery.

For example, in order to perform reconfiguration with sync, or when the timer for cell handover is started, the RRC layer instructs the lower layer to suspend LBT failure detection and recovery.

For example, the lower layer is a physical layer and/or an MAC layer.

For example, the processor 1210 may further be configured to recover a consistent LBT failure detection and recovery mechanism when the cell handover is completed.

For example, the recovering a consistent LBT failure detection and recovery mechanism includes at least one of the following: indicating an LBT failure by the physical layer to the MAC layer when an indication of recovering consistent LBT failure detection and recovery is received and LBT fails; for a serving cell configured with an LBT failure recovery configuration parameter, triggering consistent LBT failure on a BWP of the serving cell by the MAC entity when an indication of recovering consistent LBT failure detection and recovery is received, an LBT failure indication is received from the lower layer and the LBT counter is greater than or equal to the maximum value of LBT failure; and indicating consistent LBT failure by the MAC entity to a higher layer when a serving cell in which consistent LBT failure is triggered is a special cell, an indication of recovering consistent LBT failure detection and recovery is received, and consistent LBT failure has been triggered in all uplink BWPs configured with physical random access channel (PRACH) occasions on same carrier in the serving cell.

For example, the recovering a consistent LBT failure detection and recovery mechanism further includes: indicating the lower layer by the RRC layer to recover consistent LBT failure detection and recovery when RRC handover is completed or when the terminal equipment is synchronized to a second cell, the second cell being a target cell.

For example, the processor 1210 may further be configured to receive an RRC reconfiguration message from a first network device, the RRC reconfiguration message including configuration information on LBT failure detection and recovery, and the first network device being a source network device.

For example, the configuration information on LBT failure detection and recovery includes first configuration information and/or second configuration information, the first configuration information being related to LBT failure detection and recovery of a first cell, the second configuration information being related to LBT failure detection and recovery of a second cell, the first cell being a cell belonging to the source network device, and the second cell being a cell belonging to a target network device.

For example, the first cell may be a serving cell, a primary cell, a primary secondary cell or a secondary cell belonging to the source network device, and the second cell may be a serving cell, a primary cell, a primary secondary cell or a secondary cell belonging to the target network device.

For example, the source MAC entity of the terminal equipment performs consistent LBT failure detection and recovery on the first cell according to the first configuration information; and/or the target MAC entity of the terminal equipment performs consistent LBT failure detection and recovery on the second cell according to the second configuration information.

In another implementation, the apparatus for consistent LBT failure detection and recovery in cell handover and the processor 1210 may be configured separately; for example, the apparatus for consistent LBT failure detection and recovery in cell handover may be configured as a chip connected to the processor 1210, and the functions of the apparatus for consistent LBT failure detection and recovery in cell handover are executed under control of the processor 1210.

As shown in FIG. 12, the terminal equipment 1200 may further include a communication module 1230, an input unit 1240, a display 1250 and a power supply 1260. It should be noted that the terminal equipment 1200 does not necessarily include all the parts shown in FIG. 12. Furthermore, the terminal equipment 1200 may include parts not shown in FIG. 12, and the related art may be referred to.

As shown in FIG. 12, the processor 1210 is sometimes referred to as a controller or an operational control, which may include a microprocessor or other processor devices and/or logic devices. The processor 1210 receives input and controls operations of components of the terminal equipment 1200.

The memory 1220 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1210 may execute programs stored in the memory 1220, so as to realize information storage or processing, etc. Functions of other parts are similar to those of the related art, which shall not be described herein any further. The parts of the terminal equipment 1200 may be realized by specific hardware, firmware, software, or any combination thereof, without departing from the scope of this disclosure.

It can be seen from the above embodiment that during the cell handover, when the consistent LBT failure indication is received, the terminal equipment suspends data transmission and/or reception with the network device, and/or, during the cell handover, the terminal equipment suspends consistent LBT failure detection and recovery. In this way, during the cell handover, the terminal equipment will not initiate a connection reestablishment process due to the consistent LBT failure, thereby avoiding interruption of user services and degradation of user experiences.

### Embodiment 7

The embodiment of this disclosure provides a network device, including the apparatus for consistent LBT failure detection and recovery in cell handover described in Embodiment 5.

FIG. 13 is a schematic diagram of a systematic structure of the network device of Embodiment 11 of this disclosure. As shown in FIG. 13, a network device 1300 may include a processor 1310 and a memory 1320, the memory 1320 being coupled to the processor 1310. The memory 1320 may store various data, and furthermore, it may store a program 1330 for data processing, and execute the program 1330 under control of the processor 1310, so as to receive various information transmitted by a terminal equipment, and transmit various information to the terminal equipment.

In one implementation, the functions of the apparatus for consistent LBT failure detection and recovery in cell handover may be integrated into the processor 1310. The processor 1310 may be configured to: transmit an RRC reconfiguration message to a terminal equipment, the RRC reconfiguration message including configuration information on LBT failure detection and recovery.

For example, the RRC reconfiguration message further includes information needed in accessing to a second cell, the second cell being a target cell.

For example, the network device is a source network device.

For example, the configuration information on LBT failure detection and recovery includes first configuration information and/or second configuration information, the first configuration information being related to LBT failure detection and recovery of a first cell, the second configuration information being related to LBT failure detection and recovery of a second cell, the first cell being a cell belonging to a source network device, and the second cell being a cell belonging to a target network device.

For example, the first cell may be a serving cell, a primary cell, a primary secondary cell or a secondary cell belonging to the source network device, and the second cell may be a serving cell, a primary cell, a primary secondary cell or a secondary cell belonging to the target network device.

For example, the first configuration information related to LBT failure detection and recovery of the first cell is used by the source MAC entity of the terminal equipment to perform consistent LBT failure detection and recovery on the first cell, and/or the second configuration information related to LBT failure detection and recovery of the second cell is used by the target MAC entity of the terminal equipment performs consistent LBT failure detection and recovery on the second cell.

In another implementation, the apparatus for consistent LBT failure detection and recovery in cell handover and the processor 1310 may be configured separately; for example, the apparatus for consistent LBT failure detection and recovery in cell handover may be configured as a chip connected to the processor 1310, and the functions of the apparatus for consistent LBT failure detection and recovery in cell handover are executed under control of the processor 1310.

Furthermore, as shown in FIG. 13, the network device 1300 may include a transceiver 1340, and an antenna 1350, etc. Functions of the above components are similar to those in the related art, and shall not be described herein any further. It should be noted that the network device 1300 does not necessarily include all the parts shown in FIG. 13. Furthermore, the network device 1300 may include parts not shown in FIG. 13, and the related art may be referred to.

It can be seen from the above embodiment that the network device transmits an RRC reconfiguration message including the configuration information related to LBT failure detection and recovery to the terminal equipment, so that the terminal equipment is able to perform consistent LBT failure detection according to the configuration information related to LBT failure detection and recovery.

### Embodiment 8

The embodiment of this disclosure provides a communications system, including the terminal equipment described in Embodiment 7 and/or the network device described in Embodiment 8.

For example, reference may be made to FIG. 1 for a structure of the communications system. As shown in FIG. 1, the communications system 100 includes the network device 101, the second network device 102 and the terminal equipment 103. The terminal equipment 103 is identical to the terminal equipment described in Embodiment 7, and the first network device 101 is identical to the network device in Embodiment 7, with identical contents being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 11 may either correspond to software modules of procedures of a computer program, or correspond to hardware modules. Such software modules may respectively correspond to the steps shown in FIG. 3 or 4. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 11 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 11 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

According to the above implementations disclosed in the embodiments, following supplements are further disclosed.

Supplement I

1. An apparatus for consistent LBT failure detection and recovery in cell handover, applicable to a terminal equipment, the apparatus including:

a first processing unit configured to receive a consistent LBT failure indication during cell handover, and stop data transmission and/or reception with a network device; and/or

a second processing unit configured to suspend consistent LBT failure detection and recovery during the cell handover.

2. The apparatus according to supplement 1, wherein the cell handover includes:

dual active protocol stack (DAPS) handover, or

dual active protocol stack (DAPS) handover and non-DAPS handover, or

non-DAPS handover.

3. The apparatus according to supplement 1 or 2, wherein,

during the cell handover, when the consistent LBT failure indication is received, and/or when the data transmission and/or reception with the network device is/are suspended, the apparatus suspends consistent LBT failure detection and recovery.

4. The apparatus according to supplement 1 or 2, wherein,

the cell handover is dual active protocol stack (DAPS) handover,

and the first processing unit is configured to receive the consistent LBT failure indication during the cell handover, and stop data transmission and/or reception with a first network device; and/or

the second processing unit is configured to suspend consistent LBT failure detection and recovery of a target cell by the terminal equipment during the cell handover,

the first network device being a source network device.

5. The apparatus according to any one of supplements 1-4, wherein, a received consistent LBT failure indication is from an MAC layer of the terminal equipment.

6. The apparatus according to supplement 5, wherein that the received consistent LBT failure indication is from an MAC layer of the terminal equipment includes:

that the received consistent LBT failure indication is from at least one of a source MAC entity, a target MAC entity and an MCG MAC entity, of the terminal equipment.

7. The apparatus according to any one of supplements 1-6, wherein that the first processing unit suspends data transmission and/or reception with a network device includes at least one of the following:

suspending data transmission and/or reception with a first network device;

suspending data transmission and/or reception other than data transmitted related to random access with a second network device; and

suspending data transmission and/or reception with an MCG network device;

the first network device being a source network device, and the second network device being a target network device.

8. The apparatus according to any one of supplements 1-7, wherein the apparatus further includes at least one of the following units:

a keeping unit configured to keep the terminal equipment in an RRC connected state;

a release unit configured to make the terminal equipment to release connection with the first network device;

a maintaining unit configured to make the terminal equipment to maintain RRC configuration of the first network device; and

a considering unit configured to make the terminal equipment to consider that a radio link with the first network device fails,

the first network device being a source network device.

9. The apparatus according to any one of supplements 1-8, wherein the second processing unit is configured to:

suspend consistent LBT failure detection and recovery for a first cell and/or a second cell by the terminal equipment during the cell handover,

the first cell belonging to a first network device, and the second cell belonging to a second network device,

the first network device being a source network, and the second network device being a target network device.

10. The apparatus according to supplement 9, wherein,

the first cell is a serving cell or a primary cell or a primary secondary cell or a secondary cell, and/or

the second cell is a serving cell or a primary cell or a primary secondary cell or a secondary cell.

11. The apparatus according to any one of supplements 1-10, wherein that the second processing unit suspends consistent LBT failure detection and recovery includes at least one of the following:

suspending indicating LBT failure by a physical layer to an MAC layer;

not triggering consistent LBT failure by an MAC layer;

not indicating consistent LBT failure by an MAC layer to a higher layer;

receiving a consistent LBT failure indication and a timer used for cell handover being not operated, and considering that a radio link fails; or the timer being operated, receiving a consistent LBT failure indication, and not considering that a radio link fails or neglecting the consistent LBT failure indication; and

radio link failure occurring, a timer used for cell handover being not operated, and initiating connection reestablishment; or the timer being operated, radio link failure occurring, and not initiating connection reestablishment.

12. The apparatus according to any one of supplements 1-11, wherein the apparatus further includes at least one of the following units:

a first indicating unit configured to make the physical layer to indicate the LBT failure to the MAC layer when no indication for suspending consistent LBT failure detection and recovery is received and the LBT fails;

a first triggering unit configured to, for a serving cell configured with an LBT failure recovery configuration parameter, make an MAC layer to trigger a consistent LBT failure on a BWP of the serving cell when no indication for suspending consistent LBT failure detection and recovery is received, an LBT failure indication is received from a lower layer and an LBT counter is greater than or equal to an LBT failure maximum value; and

a second indicating unit configured to, when the serving cell that triggers the consistent LBT failure is a special cell and in a case where no indication for suspending consistent LBT failure detection and recovery is received and consistent LBT failure has been triggered in all uplink BWPs configured with physical random access channel (PRACH) occasions on same carrier in the serving cell, make the MAC entity indicate the consistent LBT failures to the higher layer.

13. The apparatus according to any one of supplements 1-12, wherein the second processing unit is further configured to:

indicate the lower layer by the RRC layer to suspend consistent LBT failure detection and recovery.

14. The apparatus according to supplement 13, wherein,

in order to perform reconfiguration with sync, or when the timer for cell handover is started, the RRC layer instructs the lower layer to suspend LBT failure detection and recovery.

15. The apparatus according to supplement 13 or 14, wherein,

the lower layer is a physical layer and/or an MAC layer.

16. The apparatus according to any one of supplements 1-15, wherein the apparatus further includes:

a handover completing unit configured to complete cell handover; and

a recovering unit configured to recover a consistent LBT failure detection and recovery mechanism.

17. The apparatus according to supplement 16, wherein that the recovering unit recovers a consistent LBT failure detection and recovery mechanism includes at least one of the following:

indicating an LBT failure by a physical layer to an MAC layer when an indication of recovering consistent LBT failure detection and recovery is received and LBT fails;

for a serving cell configured with an LBT failure recovery configuration parameter, triggering consistent LBT failure on a BWP of the serving cell by an MAC entity when an indication of recovering consistent LBT failure detection and recovery is received, an LBT failure indication is received from a lower layer and an LBT counter is greater than or equal to a maximum value of LBT failure; and

indicating consistent LBT failure by the MAC entity to a higher layer when a serving cell in which consistent LBT failure is triggered is a special cell, an indication of recovering consistent LBT failure detection and recovery is received, and consistent LBT failure has been triggered in all uplink BWPs configured with physical random access channel (PRACH) occasions on same carrier in the serving cell.

18. The apparatus according to supplement 16 or 17, wherein that the recovering unit recovers a consistent LBT failure detection and recovery mechanism further includes:

indicating a lower layer by a RRC layer to recover consistent LBT failure detection and recovery when RRC handover is completed or when the terminal equipment is synchronized to a second cell, the second cell being a target cell.

19. The apparatus according to any one of supplements 1-18, wherein the apparatus further includes:

a first receiving unit configured to receive an RRC reconfiguration message from a first network device, the RRC reconfiguration message including configuration information on LBT failure detection and recovery, and the first network device being a source network device.

20. The apparatus according to supplement 19, wherein,

the configuration information on LBT failure detection and recovery includes first configuration information and/or second configuration information, the first configuration information being related to LBT failure detection and recovery of a first cell, and the second configuration information being related to LBT failure detection and recovery of a second cell,

the first cell being a cell belonging to the source network device, and the second cell being a cell belonging to a target network device.

21. The apparatus according to supplement 20, wherein,

a source MAC entity of the terminal equipment performs consistent LBT failure detection and recovery on the first cell according to the first configuration information; and/or

a target MAC entity of the terminal equipment performs consistent LBT failure detection and recovery on the second cell according to the second configuration information.

22. An apparatus for consistent LBT failure detection and recovery in cell handover, applicable to a terminal equipment, the apparatus including:

a third processing unit configured to, during cell handover, when a consistent LBT failure indication is received, stop data transmission and/or reception with a network device; and/or,

a fourth processing unit configured to, during cell handover, suspend consistent LBT failure detection and recovery.

23. The apparatus according to supplement 22, wherein the cell handover includes:

dual active protocol stack (DAPS) handover, or

dual active protocol stack (DAPS) handover and non-DAPS handover, or

non-DAPS handover.

24. The apparatus according to supplement 22 or 23, wherein,

during the cell handover, when the consistent LBT failure indication is received, and/or when the data transmission and/or reception with the network device is/are suspended, the apparatus suspends consistent LBT failure detection and recovery.

25. The apparatus according to supplement 22 or 23, wherein,

the cell handover is dual active protocol stack (DAPS) handover,

during the cell handover, when the consistent LBT failure indication is received, data transmission and/or reception with a first network device is/are suspended; and/or

during the cell handover, consistent LBT failure detection and recovery for a target cell by the second terminal equipment are suspended,

the first network device being a source network device.

26. The apparatus according to any one of supplements 22-25, wherein,

the received consistent LBT failure indication is from an MAC layer of the terminal equipment.

27. The apparatus according to supplement 26, wherein that the received consistent LBT failure indication is from an MAC layer of the terminal equipment includes:

that the received consistent LBT failure indication is from at least one of a source MAC entity, a target MAC entity and an MCG MAC entity, of the terminal equipment.

28. The apparatus according to any one of supplements 22-27, wherein that the third processing unit suspends data transmission and/or reception with a network device includes at least one of the following:

suspending data transmission and/or reception with a first network device;

suspending data transmission and/or reception other than data transmitted related to random access with a second network device; and

suspending data transmission and/or reception with an MCG network device;

the first network device being a source network device, and the second network device being a target network device.

29. The apparatus according to any one of supplements 22-28, wherein the apparatus further includes at least one of the following units:

a keeping unit configured to keep the terminal equipment in an RRC connected state;

a release unit configured to make the terminal equipment to release connection with the first network device;

a maintaining unit configured to make the terminal equipment to maintain RRC configuration of the first network device; and

a considering unit configured to make the terminal equipment to consider that a radio link with the first network device fails,

the first network device being a source network device.

30. The apparatus according to any one of supplements 22-29, wherein the fourth processing unit is configured to:

suspend consistent LBT failure detection and recovery for a first cell and/or a second cell by the terminal equipment during the cell handover,

the first cell belonging to a first network device, and the second cell belonging to a second network device,

the first network device being a source network, and the second network device being a target network device.

31. The apparatus according to supplement 30, wherein,

the first cell is a serving cell or a primary cell or a primary secondary cell or a secondary cell, and/or

the second cell is a serving cell or a primary cell or a primary secondary cell or a secondary cell.

32. The apparatus according to any one of supplements 22-31, wherein that the fourth processing unit suspends consistent LBT failure detection and recovery includes at least one of the following:

suspending indicating LBT failure by a physical layer to an MAC layer;

not triggering consistent LBT failure by an MAC layer;

not indicating consistent LBT failure by an MAC layer to a higher layer;

receiving a consistent LBT failure indication and a timer used for cell handover being not operated, and considering that a radio link fails; or the timer being operated, receiving a consistent LBT failure indication, and not considering that a radio link fails or neglecting the consistent LBT failure indication; and

radio link failure occurring, a timer used for cell handover being not operated, and initiating connection reestablishment; or the timer being operated, radio link failure occurring, and not initiating connection reestablishment.

33. The apparatus according to any one of supplements 22-32, wherein the apparatus further includes at least one of the following units:

a first indicating unit configured to make the physical layer indicate the LBT failure to the MAC layer when no indication for suspending consistent LBT failure detection and recovery is received and the LBT fails;

a first triggering unit configured to, for a serving cell configured with an LBT failure recovery configuration parameter, make an MAC layer trigger a consistent LBT failure on a BWP of the serving cell when no indication for suspending consistent LBT failure detection and recovery is received, an LBT failure indication is received from a lower layer and an LBT counter is greater than or equal to an LBT failure maximum value; and

a second indicating unit configured to, when the serving cell that triggers the consistent LBT failure is a special cell and in a case where no indication for suspending consistent LBT failure detection and recovery is received and consistent LBT failure has been triggered in all uplink BWPs configured with physical random access channel (PRACH) occasions on same carrier in the serving cell, make the MAC entity indicate the consistent LBT failures to the higher layer.

34. The apparatus according to any one of supplements 22-33, wherein the fourth processing unit is further configured to:

indicate the lower layer by the RRC layer to suspend consistent LBT failure detection and recovery.

35. The apparatus according to supplement 34, wherein,

in order to perform reconfiguration with sync, or when the timer for cell handover is started, the RRC layer instructs the lower layer to suspend LBT failure detection and recovery.

36. The apparatus according to supplement 34 or 35, wherein,

the lower layer is a physical layer and/or an MAC layer.

37. The apparatus according to any one of supplements 22-36, wherein the apparatus further includes:

a handover completing unit configured to complete cell handover; and

a recovering unit configured to recover a consistent LBT failure detection and recovery mechanism.

38. The apparatus according to supplement 37, wherein that the recovering unit recovers a consistent LBT failure detection and recovery mechanism includes at least one of the following:

indicating an LBT failure by a physical layer to an MAC layer when an indication of recovering consistent LBT failure detection and recovery is received and LBT fails;

for a serving cell configured with an LBT failure recovery configuration parameter, triggering consistent LBT failure on a BWP of the serving cell by an MAC entity when an indication of recovering consistent LBT failure detection and recovery is received, an LBT failure indication is received from a lower layer and an LBT counter is greater than or equal to a maximum value of LBT failure; and

indicating consistent LBT failure by the MAC entity to a higher layer when a serving cell in which consistent LBT failure is triggered is a special cell, an indication of recovering consistent LBT failure detection and recovery is received, and consistent LBT failure has been triggered in all uplink BWPs configured with physical random access channel (PRACH) occasions on same carrier in the serving cell.

39. The apparatus according to supplement 37 or 38, wherein that the recovering unit recovers a consistent LBT failure detection and recovery mechanism further includes:

indicating a lower layer by a RRC layer to recover consistent LBT failure detection and recovery when RRC handover is completed or when the terminal equipment is synchronized to a second cell, the second cell being a target cell.

40. The apparatus according to any one of supplements 22-39, wherein the apparatus further includes:

a first receiving unit configured to receive an RRC reconfiguration message from a first network device, the RRC reconfiguration message including configuration information on LBT failure detection and recovery, and the first network device being a source network device.

41. The apparatus according to supplement 40, wherein,

the configuration information on LBT failure detection and recovery includes first configuration information and/or second configuration information, the first configuration information being related to LBT failure detection and recovery of a first cell, and the second configuration information being related to LBT failure detection and recovery of a second cell,

the first cell being a cell belonging to the source network device, and the second cell being a cell belonging to a target network device.

42. The apparatus according to supplement 41, wherein,

a source MAC entity of the terminal equipment performs consistent LBT failure detection and recovery on the first cell according to the first configuration information; and/or

a target MAC entity of the terminal equipment performs consistent LBT failure detection and recovery on the second cell according to the second configuration information.

43. An apparatus for consistent LBT failure detection and recovery in cell handover, applicable to a network device, the apparatus including:

a first transmitting unit configured to transmit an RRC reconfiguration message to a terminal equipment, the RRC reconfiguration message including configuration information on LBT failure detection and recovery.

44. The apparatus according to supplement 43, wherein,

the RRC reconfiguration message further includes information needed in accessing to a second cell, the second cell being a target cell.

45. The apparatus according to supplement 43 or 44, wherein,

the network device is a source network device.

46. The apparatus according to any one of supplements 43-45, wherein,

the configuration information on LBT failure detection and recovery includes first configuration information and/or second configuration information, the first configuration information being related to LBT failure detection and recovery of a first cell, and the second configuration information being related to LBT failure detection and recovery of a second cell,

the first cell being a cell belonging to a source network device, and the second cell being a cell belonging to a target network device.

47. The apparatus according to supplement 46, wherein,

the first configuration information is used by a source MAC entity of the terminal equipment to perform consistent LBT failure detection and recovery on the first cell; and/or

the second configuration information is used by a target MAC entity of the terminal equipment to perform consistent LBT failure detection and recovery on the second cell.

48. The apparatus according to any one of supplements 43-47, wherein the apparatus further includes:

a second receiving unit configured to receive a transmitted handover request acknowledgement message from a second network device, the second network device being a target network device.

49. The apparatus according to supplement 48, wherein,

the handover request acknowledgement message includes information needed in accessing to a target cell and configuration information on LBT failure detection and recovery, the configuration information on LBT failure detection and recovery being configuration information on performing consistent LBT failure detection and recovery on a cell in the target network device by the terminal equipment.

50. A terminal equipment, including the apparatus as described in any one of supplements 1-42.

51. A network device, including the apparatus as described in any one of supplements 43-49.

52. A communications system, including the terminal equipment as described in supplement 50 and/or the network device as described in supplement 51.

Supplement II

1. A method for consistent LBT failure detection and recovery in cell handover, applicable to a terminal equipment, the method including:

receiving a consistent LBT failure indication during cell handover, and suspending data transmission and/or reception with a network device; and/or

suspending consistent LBT failure detection and recovery during the cell handover.

2. The method according to supplement 1, wherein the cell handover includes:

dual active protocol stack (DAPS) handover, or

dual active protocol stack (DAPS) handover and non-DAPS handover, or

non-DAPS handover.

3. The method according to supplement 1 or 2, wherein,

during the cell handover, when the consistent LBT failure indication is received, and/or when the data transmission and/or reception with the network device is/are suspended, consistent LBT failure detection and recovery is suspended.

4. The method according to supplement 1 or 2, wherein,

the cell handover is dual active protocol stack (DAPS) handover,

and the consistent LBT failure indication is received during the cell handover, data transmission and/or reception with a first network device is suspended; and/or

during the cell handover, consistent LBT failure detection and recovery of a target cell by the terminal equipment is suspended,

the first network device being a source network device.

5. The method according to any one of supplements 1-4, wherein,

a received consistent LBT failure indication is from an MAC layer of the terminal equipment.

6. The method according to supplement 5, wherein that the received consistent LBT failure indication is from an MAC layer of the terminal equipment includes:

that the received consistent LBT failure indication is from at least one of a source MAC entity, a target MAC entity and an MCG MAC entity, of the terminal equipment.

7. The method according to any one of supplements 1-3 and 5-6, wherein the suspending data transmission and/or reception with a network device includes at least one of the following:

suspending data transmission and/or reception with a first network device;

suspending data transmission and/or reception other than data transmitted related to random access with a second network device; and

suspending data transmission and/or reception with an MCG network device;

the first network device being a source network device, and the second network device being a target network device.

8. The method according to any one of supplements 1-7, wherein the method further includes at least one of the following steps:

keeping the terminal equipment in an RRC connected state;

releasing connection with the first network device by the terminal equipment;

maintaining RRC configuration of the first network device by the terminal equipment; or

considering that a radio link with the first network device fails by the terminal equipment,

the first network device being a source network device.

9. The method according to any one of supplements 1-3 and 5-8, wherein the suspending consistent LBT failure detection and recovery during the cell handover includes:

suspending consistent LBT failure detection and recovery performed by the terminal equipment on a first cell and/or a second cell during the cell handover,

the first cell belonging to a first network device, and the second cell belonging to a second network device,

the first network device being a source network, and the second network device being a target network device.

10. The method according to supplement 9, wherein,

the first cell is a serving cell or a primary cell or a primary secondary cell or a secondary cell, and/or

the second cell is a serving cell or a primary cell or a primary secondary cell or a secondary cell.

11. The method according to any one of supplements 1-10, wherein the suspending consistent LBT failure detection and recovery includes at least one of the following:

suspending indicating LBT failure by a physical layer to an MAC layer;

not triggering consistent LBT failure by an MAC layer;

not indicating consistent LBT failure by an MAC layer to a higher layer;

receiving a consistent LBT failure indication and a timer used for cell handover being not operated, and considering that a radio link fails; or the timer being operated, receiving a consistent LBT failure indication, and not considering that a radio link fails or neglecting the consistent LBT failure indication; and

radio link failure occurring, a timer used for cell handover being not operated, and initiating connection reestablishment; or the timer being operated, radio link failure occurring, and not initiating connection reestablishment.

12. The method according to any one of supplements 1-11, wherein the method further includes at least one of the following steps:

indicating the LBT failure by the physical layer to the MAC layer when no indication for suspending consistent LBT failure detection and recovery is received and the LBT fails;

for a serving cell configured with an LBT failure recovery configuration parameter, triggering a consistent LBT failure on a BWP of the serving cell by an MAC layer when no indication for suspending consistent LBT failure detection and recovery is received, an LBT failure indication is received from a lower layer and an LBT counter is greater than or equal to an LBT failure maximum value; and

when the serving cell that triggers the consistent LBT failure is a special cell and in a case where no indication for suspending consistent LBT failure detection and recovery is received and consistent LBT failure has been triggered in all uplink BWPs configured with physical random access channel (PRACH) occasions on same carrier in the serving cell, indicating the consistent LBT failures by the MAC entity to the higher layer.

13. The method according to any one of supplements 1-12, wherein the suspending consistent LBT failure detection and recovery further includes:

indicating the lower layer by the RRC layer to suspend consistent LBT failure detection and recovery.

14. The method according to supplement 13, wherein,

in order to perform reconfiguration with sync, or when the timer for cell handover is started, the RRC layer instructs the lower layer to suspend LBT failure detection and recovery.

15. The method according to supplement 13 or 14, wherein,

the lower layer is a physical layer and/or an MAC layer.

16. The method according to any one of supplements 1-15, wherein the method further includes:

completing cell handover, and recovering a consistent LBT failure detection and recovery mechanism.

17. The method according to supplement 16, wherein that the recovering a consistent LBT failure detection and recovery mechanism includes at least one of the following:

indicating an LBT failure by a physical layer to an MAC layer when an indication of recovering consistent LBT failure detection and recovery is received and LBT fails;

for a serving cell configured with an LBT failure recovery configuration parameter, triggering consistent LBT failure on a BWP of the serving cell by an MAC entity when an indication of recovering consistent LBT failure detection and recovery is received, an LBT failure indication is received from a lower layer and an LBT counter is greater than or equal to a maximum value of LBT failure; and

indicating consistent LBT failure by the MAC entity to a higher layer when a serving cell in which consistent LBT failure is triggered is a special cell, an indication of recovering consistent LBT failure detection and recovery is received, and consistent LBT failure has been triggered in all uplink BWPs configured with physical random access channel (PRACH) occasions on same carrier in the serving cell.

18. The method according to supplement 16 or 17, wherein that the recovering a consistent LBT failure detection and recovery mechanism further includes:

indicating a lower layer by a RRC layer to recover consistent LBT failure detection and recovery when RRC handover is completed or when the terminal equipment is synchronized to a second cell, the second cell being a target cell.

19. The method according to any one of supplements 1-18, wherein the method further includes:

receiving an RRC reconfiguration message from a first network device, the RRC reconfiguration message including configuration information on LBT failure detection and recovery, and the first network device being a source network device.

20. The method according to supplement 19, wherein,

the configuration information on LBT failure detection and recovery includes first configuration information and/or second configuration information, the first configuration information being related to LBT failure detection and recovery of a first cell, and the second configuration information being related to LBT failure detection and recovery of a second cell,

the first cell being a cell belonging to the source network device, and the second cell being a cell belonging to a target network device.

21. The method according to supplement 20, wherein,

a source MAC entity of the terminal equipment performs consistent LBT failure detection and recovery on the first cell according to the first configuration information; and/or

a target MAC entity of the terminal equipment performs consistent LBT failure detection and recovery on the second cell according to the second configuration information.

22. A method for consistent LBT failure detection and recovery in cell handover, applicable to a terminal equipment, the method including:

during cell handover, when a consistent LBT failure indication is received, suspending data transmission and/or reception with a network device; and/or,

during cell handover, suspending consistent LBT failure detection and recovery.

23. The method according to supplement 22, wherein the cell handover includes:

dual active protocol stack (DAPS) handover, or

dual active protocol stack (DAPS) handover and non-DAPS handover, or

non-DAPS handover.

24. The method according to supplement 22 or 23, wherein,

during the cell handover, when the consistent LBT failure indication is received, and/or when the data transmission and/or reception with the network device is/are suspended, consistent LBT failure detection and recovery is suspended.

25. The method according to supplement 22 or 23, wherein,

the cell handover is dual active protocol stack (DAPS) handover,

during the cell handover, when the consistent LBT failure indication is received, data transmission and/or reception with a first network device is/are suspended; and/or

during the cell handover, consistent LBT failure detection and recovery for a target cell by the second terminal equipment are suspended,

the first network device being a source network device.

26. The method according to any one of supplements 22-25, wherein,

the received consistent LBT failure indication is from an MAC layer of the terminal equipment.

27. The method according to supplement 26, wherein that the received consistent LBT failure indication is from an MAC layer of the terminal equipment includes:

that the received consistent LBT failure indication is from at least one of a source MAC entity, a target MAC entity and an MCG MAC entity, of the terminal equipment.

28. The method according to any one of supplements 22-27, wherein the suspending data transmission and/or reception with a network device includes at least one of the following:

suspending data transmission and/or reception with a first network device;

suspending data transmission and/or reception other than data transmitted related to random access with a second network device; and

suspending data transmission and/or reception with an MCG network device;

the first network device being a source network device, and the second network device being a target network device.

29. The method according to any one of supplements 22-28, wherein the method further includes at least one of the following steps:

keeping the terminal equipment in an RRC connected state;

releasing connection with the first network device by the terminal equipment;

maintaining RRC configuration of the first network device by the terminal equipment; and

considering that a radio link with the first network device fails by the terminal equipment,

the first network device being a source network device.

30. The method according to any one of supplements 22-29, wherein the during cell handover, suspending consistent LBT failure detection and recovery, includes:

suspending consistent LBT failure detection and recovery performed by the terminal equipment on a first cell and/or a second cell during the cell handover,

the first cell belonging to a first network device, and the second cell belonging to a second network device,

the first network device being a source network, and the second network device being a target network device.

31. The method according to supplement 30, wherein,

the first cell is a serving cell or a primary cell or a primary secondary cell or a secondary cell, and/or

the second cell is a serving cell or a primary cell or a primary secondary cell or a secondary cell.

32. The method according to any one of supplements 22-31, wherein the suspending consistent LBT failure detection and recovery includes at least one of the following:

suspending indicating LBT failure by a physical layer to an MAC layer;

not triggering consistent LBT failure by an MAC layer;

not indicating consistent LBT failure by an MAC layer to a higher layer;

receiving a consistent LBT failure indication and a timer used for cell handover being not operated, and considering that a radio link fails; or the timer being operated, receiving a consistent LBT failure indication, and not considering that a radio link fails or neglecting the consistent LBT failure indication; and

radio link failure occurring, a timer used for cell handover being not operated, and initiating connection reestablishment; or the timer being operated, radio link failure occurring, and not initiating connection reestablishment.

33. The method according to any one of supplements 22-32, wherein the method further includes at least one of the following steps:

indicating the LBT failure by the physical layer to the MAC layer when no indication for suspending consistent LBT failure detection and recovery is received and the LBT fails;

for a serving cell configured with an LBT failure recovery configuration parameter, triggering a consistent LBT failure on a BWP of the serving cell by an MAC layer when no indication for suspending consistent LBT failure detection and recovery is received, an LBT failure indication is received from a lower layer and an LBT counter is greater than or equal to an LBT failure maximum value; and

when the serving cell that triggers the consistent LBT failure is a special cell and in a case where no indication for suspending consistent LBT failure detection and recovery is received and consistent LBT failure has been triggered in all uplink BWPs configured with physical random access channel (PRACH) occasions on same carrier in the serving cell, indicating the consistent LBT failures by the MAC entity to the higher layer.

34. The method according to any one of supplements 22-33, wherein the suspending consistent LBT failure detection and recovery further includes:

indicating the lower layer by the RRC layer to suspend consistent LBT failure detection and recovery.

35. The method according to supplement 34, wherein,

in order to perform reconfiguration with sync, or when the timer for cell handover is started, the RRC layer instructs the lower layer to suspend LBT failure detection and recovery.

36. The method according to supplement 34 or 35, wherein,

the lower layer is a physical layer and/or an MAC layer.

37. The method according to any one of supplements 22-36, wherein the method further includes:

when the cell handover is completed, recovering a consistent LBT failure detection and recovery mechanism.

38. The method according to supplement 37, wherein the recovering a consistent LBT failure detection and recovery mechanism includes at least one of the following:

indicating an LBT failure by a physical layer to an MAC layer when an indication of recovering consistent LBT failure detection and recovery is received and LBT fails;

for a serving cell configured with an LBT failure recovery configuration parameter, triggering consistent LBT failure on a BWP of the serving cell by an MAC entity when an indication of recovering consistent LBT failure detection and recovery is received, an LBT failure indication is received from a lower layer and an LBT counter is greater than or equal to a maximum value of LBT failure; and

indicating consistent LBT failure by the MAC entity to a higher layer when a serving cell in which consistent LBT failure is triggered is a special cell, an indication of recovering consistent LBT failure detection and recovery is received, and consistent LBT failure has been triggered in all uplink BWPs configured with physical random access channel (PRACH) occasions on same carrier in the serving cell.

39. The method according to supplement 37 or 38, wherein the recovering a consistent LBT failure detection and recovery mechanism further includes:

indicating a lower layer by a RRC layer to recover consistent LBT failure detection and recovery when RRC handover is completed or when the terminal equipment is synchronized to a second cell, the second cell being a target cell.

40. The method according to any one of supplements 22-39, wherein the method further includes:

receiving an RRC reconfiguration message from a first network device, the RRC reconfiguration message including configuration information on LBT failure detection and recovery, and the first network device being a source network device.

41. The method according to supplement 40, wherein,

the configuration information on LBT failure detection and recovery includes first configuration information and/or second configuration information, the first configuration information being related to LBT failure detection and recovery of a first cell, and the second configuration information being related to LBT failure detection and recovery of a second cell,

the first cell being a cell belonging to the source network device, and the second cell being a cell belonging to a target network device.

42. The method according to supplement 41, wherein,

a source MAC entity of the terminal equipment performs consistent LBT failure detection and recovery on the first cell according to the first configuration information; and/or

a target MAC entity of the terminal equipment performs consistent LBT failure detection and recovery on the second cell according to the second configuration information.

43. A method for consistent LBT failure detection and recovery in cell handover, applicable to a network device, the method including:

transmitting an RRC reconfiguration message to a terminal equipment, the RRC reconfiguration message including configuration information on LBT failure detection and recovery.

44. The method according to supplement 43, wherein,

the RRC reconfiguration message further includes information needed in accessing to a second cell, the second cell being a target cell.

45. The method according to supplement 43 or 44, wherein,

the network device is a source network device.

46. The method according to any one of supplements 43-45, wherein,

the configuration information on LBT failure detection and recovery includes first configuration information and/or second configuration information, the first configuration information being related to LBT failure detection and recovery of a first cell, and the second configuration information being related to LBT failure detection and recovery of a second cell,

the first cell being a cell belonging to a source network device, and the second cell being a cell belonging to a target network device.

47. The method according to supplement 46, wherein,

the first configuration information is used by a source MAC entity of the terminal equipment to perform consistent LBT failure detection and recovery on the first cell; and/or

the second configuration information is used by a target MAC entity of the terminal equipment to perform consistent LBT failure detection and recovery on the second cell.

48. The method according to any one of supplements 43-47, wherein the method further includes:

receiving a transmitted handover request acknowledgement message from a second network device, the second network device being a target network device.

49. The method according to supplement 48, wherein,
the handover request acknowledgement message includes information needed in accessing to a target cell and configuration information on LBT failure detection and recovery, the configuration information on LBT failure detection and recovery being configuration information on performing consistent LBT failure detection and recovery on a cell in the target network device by the terminal equipment.

What is claimed is:

1. An apparatus for consistent LBT failure detection and recovery in cell handover, applicable to a terminal equipment, the apparatus comprising:
a memory; and
a processor coupled to the memory and configured to:
receive a consistent uplink LBT failure indication from a target MAC or a source MAC; and
when the consistent uplink LBT failure indication is received from the source MAC, suspend data transmission and reception with a source network device; and
when the consistent uplink LBT failure indication is received from the target MAC and a timer for the cell handover being not operated, consider radio link failure to be detected for a target MCG.

2. The apparatus according to claim 1, wherein the cell handover comprises:
dual active protocol stack (DAPS) handover, or
dual active protocol stack (DAPS) handover and non-DAPS handover, or
non-DAPS handover.

3. The apparatus according to claim 1, wherein,
the processor, when the consistent uplink LBT failure indication is received from the source MAC during the cell handover, suspend the data transmission and reception with the source network device.

4. The apparatus according to claim 1, wherein,
the received consistent uplink LBT failure indication is from an MAC layer of the terminal equipment.

5. The apparatus according to claim 4, wherein the received consistent uplink LBT failure indication is from at least one of a source MAC entity and a target MAC entity of the terminal equipment.

6. The apparatus according to claim 1, wherein the processor is further configured to suspend consistent LBT failure detection and recovery during the cell handover when a situation is at least one of the following:
suspending indicating LBT failure by a physical layer to an MAC layer;
not triggering consistent LBT failure by an MAC layer;
not indicating consistent LBT failure by an MAC layer to a higher layer; and
radio link failure occurring, a timer used for cell handover being not operated, and initiating connection reestablishment; or the timer being operated, radio link failure occurring, and not initiating connection reestablishment.

7. The apparatus according to claim 1, wherein
the processor is further configured to:
complete the cell handover; and
recover a consistent LBT failure detection and recovery mechanism.

8. The apparatus according to claim 7, wherein that the processor recovers the consistent LBT failure detection and recovery mechanism comprises at least one of the following:
indicating an LBT failure by a physical layer to an MAC layer when an indication of recovering consistent LBT failure detection and recovery is received and LBT fails;
for a serving cell configured with an LBT failure recovery configuration parameter, triggering consistent LBT failure on a BWP of the serving cell by an MAC entity when an indication of recovering consistent LBT failure detection and recovery is received, an LBT failure indication is received from a lower layer and an LBT counter is greater than or equal to a maximum value of LBT failure; and
indicating consistent LBT failure by the MAC entity to a higher layer when a serving cell in which consistent LBT failure is triggered is a special cell, an indication of recovering consistent LBT failure detection and recovery is received, and consistent LBT failure has been triggered in all uplink BWPs configured with physical random access channel (PRACH) occasions on same carrier in the serving cell.

9. The apparatus according to claim 7, wherein that the processor recovers the LBT failure detection and recovery mechanism further comprises:
indicating a lower layer by a RRC layer to recover consistent LBT failure detection and recovery when RRC handover is completed or when the terminal equipment is synchronized to a second cell, the second cell being a target cell.

10. The apparatus according to claim 1, wherein the apparatus further comprises:
a receiver configured to receive an RRC reconfiguration message from a first network device, the RRC reconfiguration message comprising configuration information on LBT failure detection and recovery, and the first network device being the source network device, wherein
the consistent uplink LBT failure indication is indication according to the configuration information.

11. The apparatus according to claim 10, wherein,
the configuration information on LBT failure detection and recovery comprises first configuration information and/or second configuration information, the first configuration information being related to LBT failure detection and recovery of a first cell, and the second configuration information being related to LBT failure detection and recovery of a second cell,
the first cell being a cell belonging to the source network device, and the second cell being a cell belonging to a target network device.

12. The apparatus according to claim 11, wherein,
the source MAC entity of the terminal equipment performs LBT failure detection and recovery on the first cell according to the first configuration information; and/or
the target MAC entity of the terminal equipment performs LBT failure detection and recovery on the second cell according to the second configuration information.

13. A network device, comprising:
a processor configured to configure a configuration information on LBT failure detection and recovery; and
a transmitter configured to transmit a Radio Resource Control message including the configuration information to a terminal equipment, wherein
the processor is further configured to:
control to cause the terminal equipment to suspend data transmission and reception with a source network device when a consistent uplink LBT failure indication is received from the source MAC, and
control to cause the terminal equipment to consider radio link failure to be detected for a target MCG when the consistent uplink LBT failure indication is received from the target MAC and a timer for the cell handover being not operated.

14. The network device according to claim 13, wherein,
the consistent uplink LBT failure indication is indication according to the configuration information.

15. The network device according to claim 14, wherein,
the configuration information on LBT failure detection and recovery comprises first configuration information and/or second configuration information, the first configuration information being related to LBT failure detection and recovery of a first cell, and the second configuration information being related to LBT failure detection and recovery of a second cell,
the first cell being a cell belonging to a source network device, and the second cell being a cell belonging to a target network device.

16. The network device according to claim 14, wherein the network device further comprises:
a receiver configured to receive a transmitted handover request acknowledgement message from a second network device, the second network device being a target network device.

17. The network device according to claim 16, wherein,
the handover request acknowledgement message comprises information needed in accessing to a target cell and configuration information on LBT failure detection and recovery, the configuration information on LBT failure detection and recovery being configuration information on performing LBT failure detection and recovery on a cell in the target network device by the terminal equipment.

18. A communications system, comprising a terminal equipment and/or a network device, the terminal equipment comprising:
an apparatus for consistent LBT failure detection and recovery in cell handover, applicable to a terminal equipment, the apparatus comprising:
a memory; and
a processor coupled to the memory and configured to:
receive a consistent uplink LBT failure indication from a target MAC or a source MAC; and
when the consistent uplink LBT failure indication is received from the source MAC, suspend data transmission and reception with a source network device; and
when the consistent uplink LBT failure indication is received from the target MAC and a timer for the cell handover being not operated, consider radio link failure to be detected for a target MCG, and
a network device, comprising:
a processor configured to configure a configuration information on LBT failure detection and recovery; and
a transmitter configured to transmit a Radio Resource Control message including the configuration information to a terminal equipment, wherein
the processor is further configured to:
control to cause the terminal equipment to suspend data transmission and reception with a source network device when a consistent uplink LBT failure indication is received from the source MAC, and
control to cause the terminal equipment to consider radio link failure to be detected for a target MCG when the consistent uplink LBT failure indication is received from the target MAC and a timer for the cell handover being not operated.
